(19) United States
(12) Patent Application Publication
(10) Pub. No.: US 2018/0289570 A1
(43) Pub. Date: Oct. 11, 2018

(54) Patient Moving System

(71) Applicant: 3M INNOVATIVE PROPERTIES COMPANY, St. Paul, MN (US)

(72) Inventors: Jenna Burns, Mequon, WI (US); Kemin Fena, Duluth, MN (US); Korey W. Karls, Woodbury, MN (US); Elizabeth Martin, Alma, MI (US); Zachery H. Nelson, Essexville, MI (US); Rebecca Rutherford, Holland, MI (US); Matthew T. Scholz, Woodbury, MN (US); Orhan Soykan, Shoreview, MN (US)

(21) Appl. No.: 15/949,590

(22) Filed: Apr. 10, 2018

Related U.S. Application Data
(60) Provisional application No. 62/484,222, filed on Apr. 11, 2017.

(51) Int. Cl. A61G 7/10

(52) U.S. Cl. CPC A61G 7/103; A61G 7/1021

(57) ABSTRACT

Aspects of the present disclosure relate to a patient moving system. The patient moving system can include a support structure which further includes a first support member, a second support member and a third support member, the second support member is arranged parallel to the third support member. The system can also include a flexible member removably attached to the second support member and the third support member. The system can also include a tensioning device mechanically coupled to at least the flexible member and configured to provide tension to the flexible member.

### BACKGROUND

Patients, and particularly non-ambulatory patients, in healthcare facilities, such as hospitals and nursing homes, may need to be transferred from one location to another. For example, patients may be transferred between at least one of a hospital bed, a gurney or stretcher, a surgical table in an operating room, cardiac catheterization lab, a diagnostic table (e.g., a table used during CT, MRI and/or other diagnostic evaluations), etc., and combinations thereof. For example, a patient may need to be moved from a hospital bed that must remain in a patient's room, to a gurney and then from the gurney to a treatment table, such as a surgical table. Following treatment, the reverse patient handling sequence may need to occur. Many of such patient transfers occur between surfaces at or near the same level making it a horizontal or near horizontal transfer.

In some patient transfer situations, sliding a patient along a supporting surface is minimized to avoid skin damage particularly in patients with fragile skin as well as to avoid causing patient pain or discomfort, such as when the patient has unhealed surgical incisions. However, lifting of the patient may also need to be minimized both for patient comfort and for worker safety. In some cases, a combination of sliding and lifting may be employed, and/or multiple healthcare personnel may need to be involved in the transfer.

In addition, controlling patient temperature can be a critical element to good care. For example, patient warming devices can be used to actively warm patients or portions of patients (e.g., selectively warm) during a variety of medical procedures, such as surgeries.

In such situations, the entire patient can be warmed or a portion of the patient can be warmed to avoid a potentially detrimental drop in core body temperature during a medical procedure, such as an extended surgery. In other situations, it may be beneficial to cool the patient, for example, during cardiac surgery or immediately after cardiac arrest.

### SUMMARY

Aspects of the present disclosure relate to a patient moving system. The patient moving system can include a support structure which further includes a first support member, a second support member and a third support member, the second support member is arranged parallel to the third support member. The system can also include a flexible member removably attached to the second support member and the third support member. The system can also include a tensioning device mechanically coupled to at least the flexible member and configured to provide tension to the flexible member.

Aspects of the present disclosure also relate to a method of moving a patient. The method can include sliding the flexible member of the patient moving system under a patient. The method can include attaching the flexible member to the second support member and the third support member. The method can also include applying tension to the flexible member by moving the second support member laterally and in an opposite direction from the third support member; wherein the tensile force is at least 3700 N. The method can also include allowing the patient to move from a first height to a second height.

Aspects of the present disclosure also relate to a patient moving system. The patient moving system comprises a corrugated plastic board. The corrugated plastic board comprises a first layer, a second layer, and a plurality of support columns contacting both the first layer and the second layer. A plurality of channels are formed from at least two support columns and the first layer and the second layer. A plurality of perforations are formed within the second layer, and at least some of the plurality of perforations are fluidically coupled to the plurality of channels. The patient moving system also includes a fluidic manifold having an inlet integrally formed from at least one layer of material. The the inlet is configured to receive a fluid from a fluidic source. The fluidic manifold also includes a chamber formed from the material and is fluidically coupled to the plurality of channels.

### BRIEF DESCRIPTION OF THE DRAWINGS

FIG. 1A illustrates an elevational view of a patient moving system.

FIG. 1B illustrates a side cross-sectional view of the patient moving system of FIG. 1A, viewed along line 1-1.

FIGS. 2A-2B illustrate a side cross-sectional view of the patient moving system of FIGS. 1A-1B in a relaxed state and in an tensioned state.

FIG. 3 illustrates a top elevational view of the patient moving system of FIGS. 1-2 shown in an extended position.

FIG. 4 illustrates a top elevational view of a portion of the patient moving system of FIGS. 1-3.

FIG. 5 illustrates a side cross-sectional view of a portion of the patient moving system of FIGS. 1-4, viewed along line 3-3.

FIGS. 6A-6B illustrate a side cross sectional view of a support member of the patient moving system of FIGS. 1-3, viewed along line 2-2.

FIG. 7A illustrates a top elevational view of another embodiment a patient moving system.

FIG. 7B illustrates a side cross-sectional view of the patient moving system of FIG. 7A, viewed along line 4-4.

FIG. 8 illustrates a side cross-sectional view of the patient moving system of FIG. 7, shown in a tensioned state.

FIG. 9A illustrates side view of an embodiment of the flexible member of a patient moving system, shown in a relaxed state.

FIG. 9B illustrates a side view of the embodiment in FIG. 9A, shown in a tensioned state.

FIG. 10A illustrates a top elevational view of an embodiment of a patient moving system.

FIG. 10B illustrates a side cross-sectional view of the patient moving system of FIG. 10A, viewed along line 5-5.

FIG. 10C illustrates a side cross-sectional view of the patient moving system of FIGS. 10A-10B, viewed along line 6-6.

FIG. 10D illustrates a bottom elevational view of the patient moving system of FIGS. 10A-10C.

FIG. 11 illustrates a perspective expanded view of an embodiment of a portion of the patient moving system.

FIG. 12 illustrates a perspective view of a patient moving system used in conjunction with a bed.

FIG. 13A illustrates a perspective view of a patient moving system.

FIG. 13B illustrates perspective view of a portion of the patient moving system of FIG. 13A.

FIG. 14A illustrates a perspective view of a patient moving system, viewed from the top right front.

FIG. 14B illustrates a perspective view of the patient moving system of FIG. 14A, viewed from the bottom front.

FIG. 14C illustrates a perspective view of a portion of the patient moving system of FIGS. 14A-B, viewed from the top front.

FIG. 14D illustrates a perspective view of a portion of the patient moving system of FIGS. 14A-C, viewed from the top right front.

FIG. 14E illustrates a perspective view of a portion of the patient moving system of FIGS. 14A-D, viewed from the top right back.

FIG. 15A illustrates a perspective view of an embodiment of a patient moving system, viewed from the top left front.

FIG. 15B illustrates a perspective view of the patient moving system of FIG. 15A, viewed from the bottom left rear.

FIG. 16 illustrates a perspective view of a portion of the patient moving system, viewed from the top front right.

### DETAILED DESCRIPTION

Aspects of the present disclosure relate to various patient moving systems using such mechanisms as tensioning to provide lift, or friction reduction mechanisms to reduce drag on a bed.

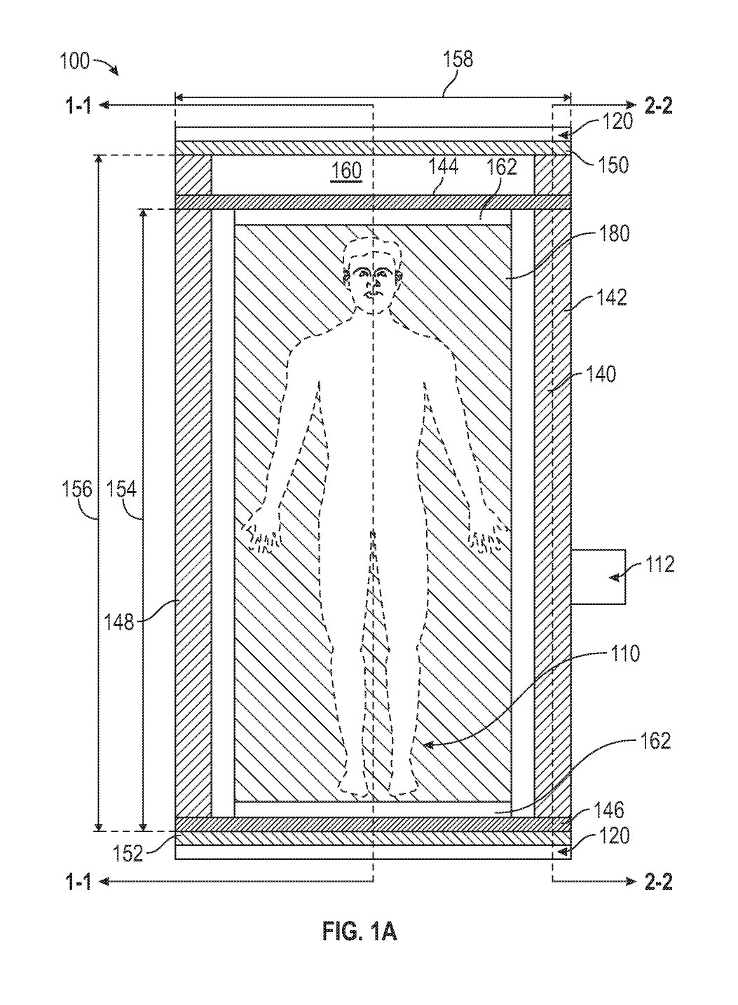

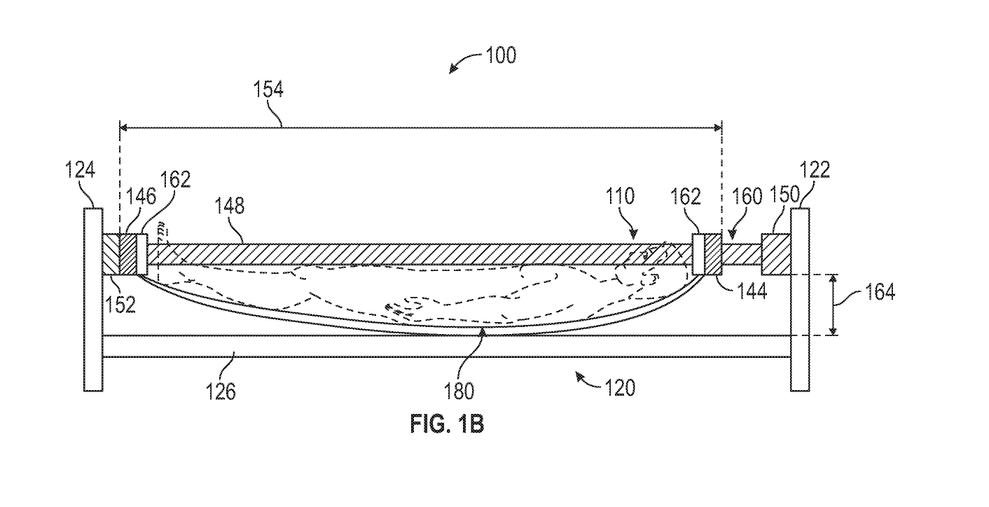

FIGS. 1-6 illustrates an embodiment of a patient moving system 100. The patient moving system 100 may have movable support members to tension a flexible member which may further lift a patient.

In FIG. 1A, the patient moving system 100 is shown with a support surface 120, support structure 140, and a flexible member 180.

An aspect of the present disclosure is that the support structure 140 can tension the flexible member 180 to lift a patient from a support surface 120.

A patient 110 on supportive surface 120, such as a bed, hospital bed, cot, stretcher, or other surface on which an individual may repose, may be repositioned using system 100. Throughout this disclosure, the term bed may be used interchangeably with supportive surface.

The support structure 140 may mechanically couple with the bed or may be used separate from the bed 120. In at least one embodiment, the support structure 140 may be integrated with the bed 120.

The support structure 140 is a generally rectangular shape to match the dimensions of a bed 120. The support structure 140 can include support members 142, 144, 146, and 148. The support members can provide rigidity to the overall support structure 140. The support members are sufficiently rigid to maintain position when subjected to lateral forces sufficient to provide tension to the flexible member 180. The support structure 140 can also include sliding mechanism 150 and 152. As shown in system 100, the sliding mechanism 150, 152 attach the support structure 140 to the bed 120. In at least one embodiment, the sliding mechanism 150, 152 can also anchor to a cart-like apparatus for mobility of the support structure 140 when moving between various supportive surfaces 120.

The support structure 140 can have at least a 3 support members and an optional fourth support member. The fourth support member 148 can add further rigidity to the support structure 140. Support member 144 is shown arranged parallel to support member 146 and support member 142 is shown arranged parallel to support member 148. The support member 142 is mechanically coupled to support member 144 and support member 146. Support member 148 is also mechanically coupled to support member 144 and support member 146. In at least one embodiment, either the support member 144 or 146, or both can be movable (e.g., slidably fastened) along the axis formed by support member 142.

The support structure 140 can have a longitudinal dimension 154 which is defined by the support members 142, and 148. The longitudinal dimension 154 corresponds to an anteroposterior axis of a patient 110. For example, the longitudinal dimension 154 can be parallel to the anteroposterior axis of a patient 110. The longitudinal dimension 154 is also parallel to the support member 142. The longitudinal dimension can be the same for the support member 148 as support member 142. In at least one embodiment, the longitudinal dimension 154 may change longitudinally within the support structure 140. For example, if support members 142 and 148 are slidable, then the longitudinal dimension may not be fixed and can vary as support member 144 is moved away from support member 146. Thus, in an extended position, support member 148 may have a longitudinal dimension 156. In at least one embodiment, the longitudinal dimension 154 corresponds to a relaxed state or home position whereas longitudinal dimension 156 corresponds to a tensioned state or an extended position. The support members 142 and 148 can be arranged parallel to the anteroposterior axis of the patient 110 or the axis formed by the longitudinal dimension 154.

In at least one embodiment, a gap 160 formed from the sliding mechanism and the support member 144 can exist. The spacing of the gap 160 depends on the longitudinal dimension 156. The gap 160 is also formed from the support members 142 and 148.

The support structure 140 can have a width dimension 158 defined by the support members 146 and 144. In the embodiment in FIG. 1A, the width dimension 158 is fixed and support members 146 and 144 are not slidable with respect to one another along the width dimension 158. The width dimension 158 generally corresponds to a mediolateral axis of the patient 110. For example, the width dimension 158 is parallel to a mediolateral axis of the patient 110. As shown in FIG. 1A, the width dimension 158 is the same for support member 144 and support member 146. The support members 144 and 146 are arranged parallel to the mediolateral axis of the patient 110 or the axis formed by the width dimension 158.

The support structure 140 can also include gripping members 162 attached thereon. The gripping members 162 may function to secure a flexible member 180. In some embodiments, a gripping member 162 (e.g., a fabric clamp) may provide structure such that when a load is applied to flexible member 180, the load is borne initially by support member 144 or 146.

The gripping member 162 is mechanically coupled to at least a portion of the support structure. In at least one embodiment, the gripping member 162 is configured to compress a portion of the flexible member to cause sufficient friction to prevent the flexible member 180 from slipping. Thus, the gripping member 162 can have sufficient friction sufficient to prevent slipping during tension of the flexible member 180. Examples of gripping members 162 include clamps, hooks, adhesives, pins, rollers, and other mechanical fasteners. Other examples of gripping members 162 are described herein.

The system 100 can also include a flexible member 180. As used herein the term “flexible member” refers to a material that drapes or conforms to an object over which it is placed and cannot support its own weight. A drape stiffness test can determine the bending length of a fabric using the principle of cantilever bending of the fabric under its own weight. A higher number indicates a stiffer fabric. The bending length is a measure of the interaction between fabric weight and fabric stiffness. In the drape stiffness test, a 1 inch (2.54 cm) by 8 inch (20.32 cm) fabric strip is slid, at 4.75 inches per minute (12 cm/min) in a direction parallel to its long dimension so that its leading edge projects from the edge of a horizontal surface. The length of the overhang is measured when the tip of the specimen is depressed under its own weight to the point where the line joining the tip of the fabric to the edge of the platform makes a 41.5 degree angle with the horizontal. The drape stiffness is calculated as 0.5 times the bending length. A total of 5 samples of each fabric should be taken. This procedure conforms to ASTM standard test D-1388 except for the fabric length which is different (longer). The test equipment used is a Cantilever Bending tester model 79-10 available from Testing Machines Inc., 400 Bayview Ave., Amityville, N.Y. 11701. As in most testing, the sample should be conditioned to ASTM conditions of 65.+−.2 percent relative humidity and 72.+−.2.degree. F. (22.+−.1.degree. C.), or TAPPI conditions of 50.+−. 2 percent relative humidity and 72.+−.1.8.degree. F. prior to testing. Preferred flexible members have a drape value of less than 10 cm, preferably less than 8 cm, more preferably less than 6 cm and most preferably less than 4 cm.

The flexible member 180 may be a bed sheet, bed linen, sling, plastic sheet, blanket, quilt, quilted bat, or any other material that may be used to support an individual. The flexible member 180 may provide a stable, flexible, lifting platform on which to lift patients. Some exemplary flexible members 180 may be made of vinyl, nylon, canvas, polyesterterephthalate(PET), aliphatic polyesters such as polylactic acid, polybutylenesuccinate and the like, polyolefins such as polypropylene, and polyethylene, and natural fibers such as cotton, rayon, viscose, hemp, etc. These materials are usually formed into fibers and further processed into non-wovens, woven or knits fabrics, bed sheets, draw sheets, mattress pads, or other materials or configuration sufficient to accomplish lifting a patient or a portion of a patient reposing on flexible member 180, as desired. In other embodiments, harnesses, slings, stretchers or other known suspension supports may also be used in and with the embodiments disclosed herein. An aspect of the present disclosure is that flexible member can have a tensile strength of at least 8 N/cm to provide lift to the patient 110 and maintain structural integrity while under tension. In at least one embodiment, the flexible member 180 is made from a multicomponent nonwoven. Preferably, the multicomponent nonwoven is a sheath/core fiber construction. Typically the sheath/core structure will comprise a high-tensile semi-crystalline polymer in the core and a lower melting point polymer in the sheath in order to thermally bond the nonwoven fibers together by means such as calendaring, hot air impingement, and the like. In these processes, the sheath component at least partially melts and bonds to the sheath component of adjacent fibers to form a bond.

The flexible member 180 can be a fabric or a fabric-like material. Generally, a fabric is woven, or knitted, whereas fabric-like materials, such as felt can be a non-woven material. While generally lacking tensile strength, a solid polymeric film can also be used. Various reinforcing filaments or fibers such as para-aramid synthetic fibers, or even natural materials such as hemp or cotton may be used to increase the tensile strength. Due to the weight distribution of a patient 110, a sheet-like shape can be advantageous for use as a flexible member 180.

Film/fabric laminates may be used in order to provide flexibility and comfort to the patient and a liquid barrier to strike through in case body fluids such as urine are emitted by the patient. In at least one embodiment, the film/fabric laminate is instantaneously absorbent to water at 23 degrees Celsius when a 100 microliter drop is gently placed on the fabric.

Multilayer articles of the present disclosure also include a barrier layer. The barrier layer may comprise one or more plies. As used herein the term “barrier layer” refers to a layer that does not allow liquid water to pass through at a pressure of 5 kPa when tested by the Hydrohead method as described in I. S. EN 20811-1993 Textiles—Determination of Resistance to Water Penetration-Hydrostatic Pressure Test. In at least one embodiment, barrier layers exceed 7.5 kPa or even 10 kPa when tested by this method. In some embodiments, barrier layers do not allow liquid water to pass through when tested by the Hydrohead method as described in I. S. EN 20811-1993 at 6 kPa per minute pressure increase with the barrier side up and no other support.

As shown in FIG. 1A, the flexible member 180 is removably attached to the support member 144 and the support member 146. For example, the flexible member 180 is attached to the gripping members 162 which is further mechanically coupled to the support members 144 and 146.

The system 100 can also include a tensioning device 112. The tensioning device 112 provides tension to the flexible member 180 sufficient to lift a patient 110. Multiple tensioning devices can exist to mechanically increase tension of the flexible member 180. The force for a tensioning device 112 can be generally manually or be assisted by a motor. For example, if manual, a lever mechanism can be used for a caregiver to gain a mechanical advantage for the force required to tension the flexible member 180. The tensioning device 112 can have a gear-based mechanism. Examples of tensioning device include pulley systems, worm drives, torsion drives, rack and pinion, and harmonic drives.

The tensioning device 112 can be mechanically coupled (indirectly) to the flexible member. For example, the a tensioning device 112 can move a portion of the support structure 140 such that force is transferred through the gripping member 162 and then through the flexible member 180. In at least one embodiment, the tensioning device 112 does not contact the flexible member 180 directly.

In at least one embodiment, the tensioning device 112 tensions the flexible member 180 along an axis parallel to the support member 142. The tensioning device 112 can be coupled to a portion of the support structure. For example, the tensioning device 112 is shown as adjacent to the support member 142. As shown in FIG. 1A, the tensioning device allows uniform tensioning of the flexible member 180 between the support members 144 and 146.

FIG. 1B illustrates a side cross-sectional view of the system 100. The bed 120 can have support columns 122 and 124. The support columns 122 and 124 can each be coupled to the base 126. The base 126 can support the patient, either directly (such as a platform, or a surgical table) or through a padded surface (such as a mattress).

In at least one embodiment, the bed 120 can have a first end and a second end. The first end can be defined partially by the column 122 and the second end can be defined partially by the column 124. In at least one embodiment, the sliding mechanisms 150 and 152 can be a linear-motion bearing or linear slide designed to provide free motion in one direction. Examples of linear slides are dovetail slides, ball bearing slides, and roller slides.

As shown, the support members 144, 146, and 148 are shown as coplanar. For example, support members 144 and 146 can be coplanar with each other. However, it may be advantageous to have support members 144 and 146 in a non-planar configuration when moving a patient 110 from an angled surface to a flat surface to minimize patient 110 disturbance. In at least one embodiment, the support members, 144, 146, and 148 can have an adjustable height relative to each other.

The height dimension 164 indicates the level that a patient 110 can be lifted through tension of the flexible member 180. A height dimension 164 can be established by the support members 144 and 146, specifically where a portion of the flexible member 180 contacts either the gripping member or the support members 144 and 146. In at least one embodiment, if the support members 144 and 146 are uneven, then the height dimension is partially established by the lower of the two. The height dimension may also be established by either the nadir of the flexible member 180 (with the patient 110) or the base 126 supporting the patient 110.

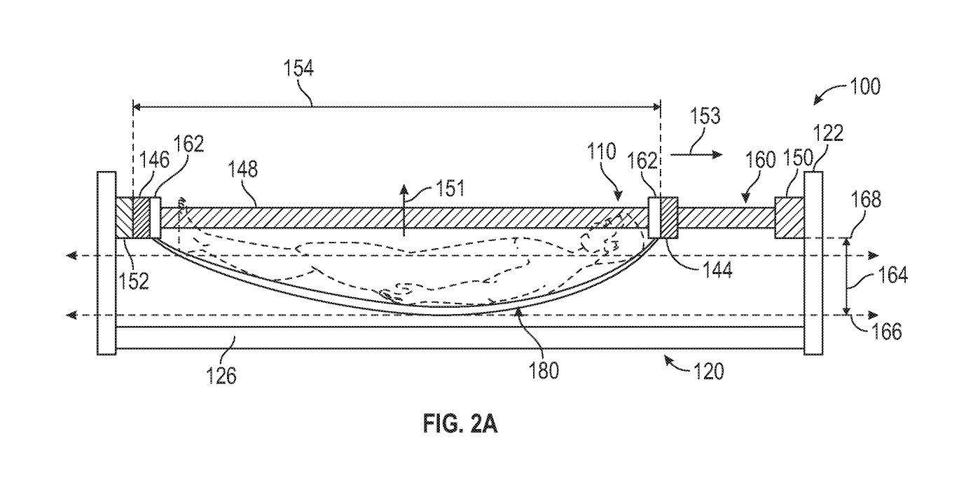

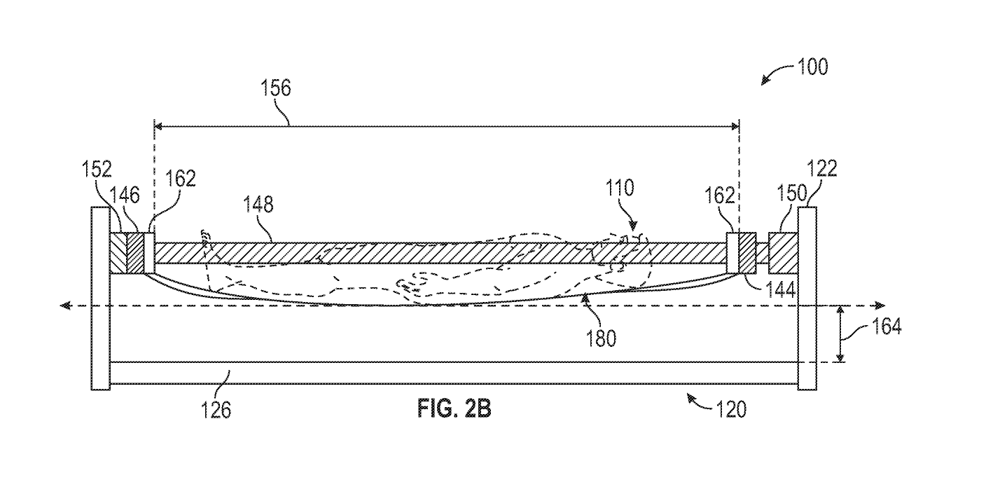

FIG. 2A-2B illustrates the system 100 in a transition from a relaxed state to a tensioned state. The system 100 in the relaxed state is the same as in FIG. 1B except that the patient 110 is shown slightly elevated above the base 126 in FIG. 2A.

In operation, the flexible member 180 may be slid under the patient 110. The flexible member 180 can be attached to the support members 144 and 146. For example, the flexible member 180 can be attached to the gripping members 162 (which are coupled to the support members 144 and 146. In order to ensure adequate grip force, the flexible member 180 may incorporate at least a grip interface with a high-friction material such as a pressure sensitive adhesive or elastomer such as styrene block copolymers including styrene-isoprene-styrene and styrene-butadiene-styrene, polyisoprene, polyurethanes, polyolefins, and metallocene polyolefins and the like.

Tension can be applied to the flexible member 180 by moving the support member 144 laterally toward the sliding mechanism 150 in an opposite direction from the support member 146. The lateral motion can occur on the same plane as the support members 144 and 146 and is indicated by arrow 153. Since the flexible member 180 is attached to the support members 144 and 146, then the tension is applied to the flexible member 180. In at least one embodiment, the tensile force applied to the flexible member 180 is at least 3700 N.

In at least one embodiment, the tension can be increased not only on the support members 144 and 146 but across support member 148 and the opposing support member (not pictured) to raise a heavier patient 110.

The lateral motion to move the support member 144 can come from a tensioning device such as a manually operated device. The manual device can be a hand crank, a ratchet system, or a pulley.

The increased tension of the flexible member 180 allows the patient 110 to move from a first height 166 to a second height 168 in accordance with the arrow 151. The first height 166 is shown as the relaxed state where a patient 110 is lifted from the base 126. In at least one embodiment, the first height is roughly coplanar with the base 126. The second height 168 is some position between where the flexible member 180 contacts the support member 144 or 146 and the first height 166.

In at least one embodiment, the movement 153 (along the same plane) of support member 144 from a home position having a longitudinal dimension 154 to an extended position having a longitudinal dimension 156 sufficient to lift the patient 110.

Likewise, the process can be reversed to lower a patient 110. For example, from the extended position 156, the support member 144 can be moved laterally towards the support member 146 in order to reduce tension to the flexible member 180 and allowing the patient 110 to move from the second height 168 to the first height 166.

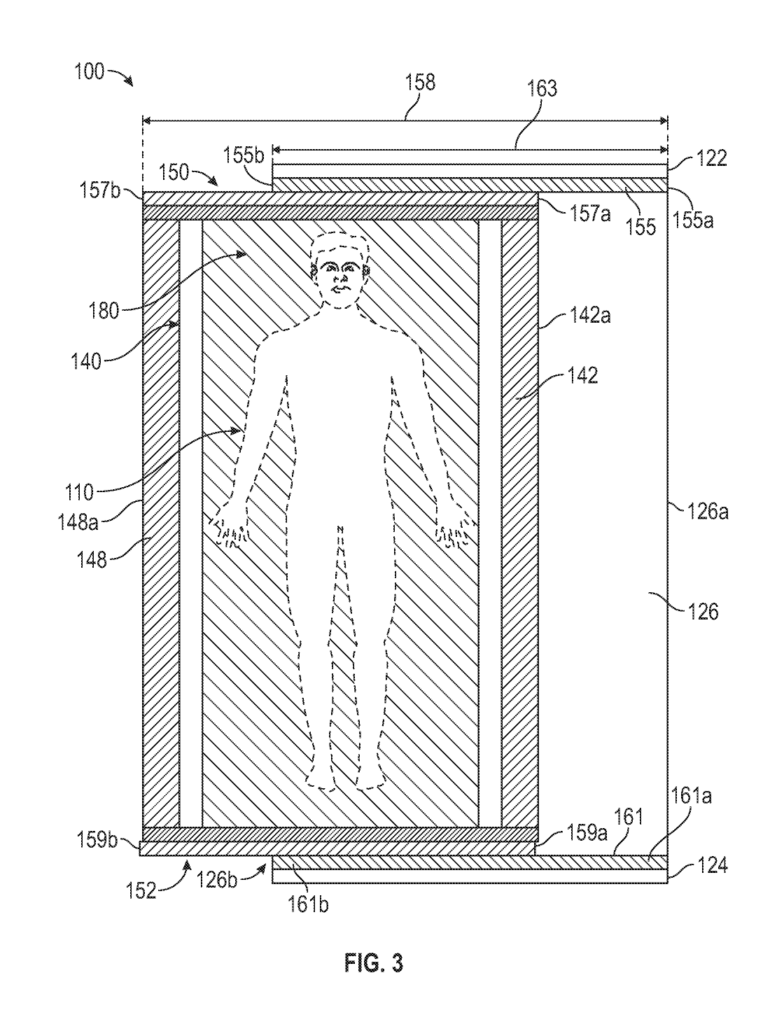

FIG. 3 illustrates the system 100 in an extended position. The sliding mechanism 150 and 152 are illustrated with greater detail.

A linear slide (a type of sliding mechanism 150) can have at least a slide frame 157 and a carriage 155. In at least one embodiment, a portion of the carriage 155 can be mechanically coupled to a column 122. Similarly, the sliding mechanism 152 can have at least a slide frame 159 and a carriage 161. A portion of the carriage 161 can be mechanically coupled to a column 124.

The slide frames 157 and 159 can be mechanically coupled to a portion of the support structure 140.

In a home position, where the patient 110 is centered over the base 126, a portion of the support member 142 (e.g., the edge) may align along a vertical plane established by the an edge portion 126a. The home position may correspond to the width dimension 158, where an edge portion 148a of support member 148 is aligned with the edge of the column 122 and the base 126.

In an extended position, the edge portion 142a of support member 142 can be in a position within the boundaries of the base 126. The edge portion 142a can also stopped by an end cap of the carriage to prevent over-extending the support structure 140 with the patient 110 (e.g., the edge 142a past edge 128b). In an extended position, the width dimension 158 is less than double the width dimension 163 of the support structure 140. The width dimension 163 corresponds to the distance between the edge portion 126a and the edge portion 148a.

In at least one embodiment, the slide frame 157 can have a first end 157a and a second end 157b, and the slide frame 159 can have a first end 159a and a second end 159b.

The first carriage 155 can have a first end 155a slidably supported by the first slide frame 157, movable between a first extended position and a home position. The first extended position can be established by the first end 157a is between the first end 155a and the second end 155b. A home position can be established when first end 155a is aligned with the first end 157a. Similarly, the carriage 161 can have a first end 161a slidably supported by the first slide frame 159, movable between a first extended position and a home position. The first extended position can be established by the first end 159a is between the first end 161a and the second end 161b. A home position can be established when first end 159a is aligned with the first end 161a. In at least one embodiment, a portion of the support structure 140 is mechanically coupled to a portion of the first carriage 155 and a portion of the second carriage 161.

FIG. 4 illustrates an embodiment of a flexible member 180. The flexible member 180 can have a patient contact zone 181. The patient contact zone 181 is an area of the flexible member that receives a patient. The flexible member 180 can have a longitudinal dimension 184 and a width dimension 182. In at least one embodiment, the flexible member 180 is characterized by low elasticity, (e.g., a material having a modulus of elasticity of at least 5 GPa). In at least one embodiment, the longitudinal dimension 180 or the width dimension 182 should not stretch more than 10%, more than 20%, more than 30%, or more than 40% under a static load of 80 kg. The unstretched longitudinal dimension can be at least 170 cm and the width dimension can be at least 70 cm.

The flexible member 180 can support a weight of at least 75 kilograms. The flexible member 180 can also have a relatively high tensile strength. For example, 54. the flexible member 180 has a tensile strength of 2 MPa to 35 MPa (inclusive). In at least one embodiment, the flexible member 180 has a tensile strength of 6 MPa. In at least one embodiment, the flexible member 180 can have a tensile strength of at least 8 N/cm, at least 12 N/cm, or at least 16 N/cm.

The flexible member 180 can have one or more coupling elements for coupling to the support structure that are preferably disposed adjacent to a portion of the periphery of the flexible member 180. In at least one embodiment, the coupling elements e.g., 186 and 188, and any other features of the flexible member 180 may be located at or towards the edges of the sheet and in practice lie outside of the upper contact surface of the sheet so as not to get caught under a laying patient. The coupling elements are preferably disposed along longitudinal sides of the flexible member 180 and may be substantially evenly spaced along the longitudinal sides.

In an embodiment, there may be provided at least one coupling element 186, 188 disposed along at least one transverse side, or end, of the flexible member 180. This coupling element would preferably be located at the foot and/or head end of the sheet and be used to support and hold the feet/legs and/or head of a patient.

Advantageously, the coupling elements 186, 188 include straps (not shown). The straps may be attached to the sheet, while in another embodiment the straps may be removable and attachable, for instance by hooks or the like on the sheet. Preferably, the straps are adjustable in length.

In at least one embodiment, the coupling element can be an area of high friction. For example, the flexible member 180 can optionally include a contact area 186, 188 on an end of the flexible member 180 to interface with the gripping member. The contact area 186, 188 may include a coating, surface finish, applied material, or other technique to provide a slip-resistant surface. For example, contact areas 186, 188 may be coated with rubber, foam tape, or other applied material, or may have a rough surface from machining, rough sanding, or other manufacturing process. The high friction surface may include a pressure-sensitive adhesive or elastomer such as styrene block copolymers including styrene-isoprene-styrene and styrene-butadiene-styrene, polyisoprene, polyurethanes, polyolefins, and in particular metallocene polyolefins and the like. In some embodiments, the slip-resistant surface features may be applied to contact areas of support members (e.g., 142, 144, 146, and 148 of FIG. 1A) or to corresponding regions of the gripping member 162 that may contact flexible member 180.

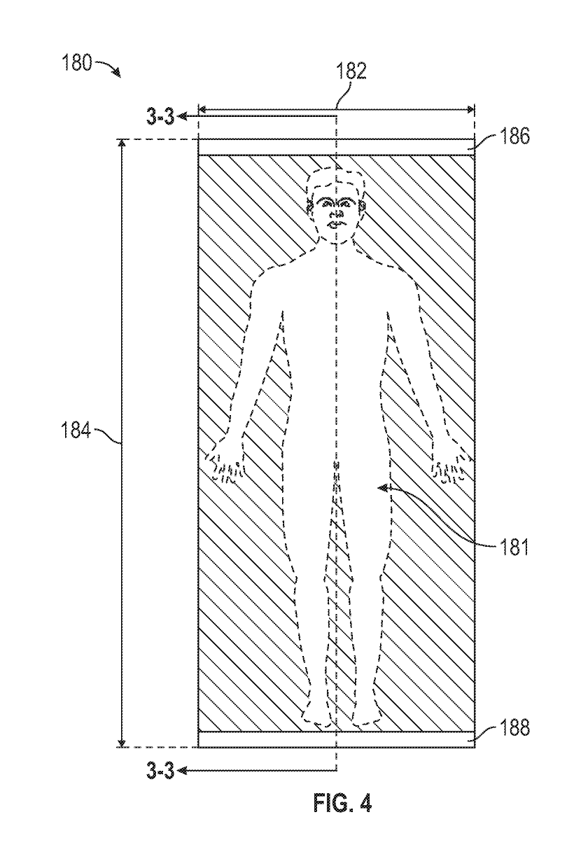

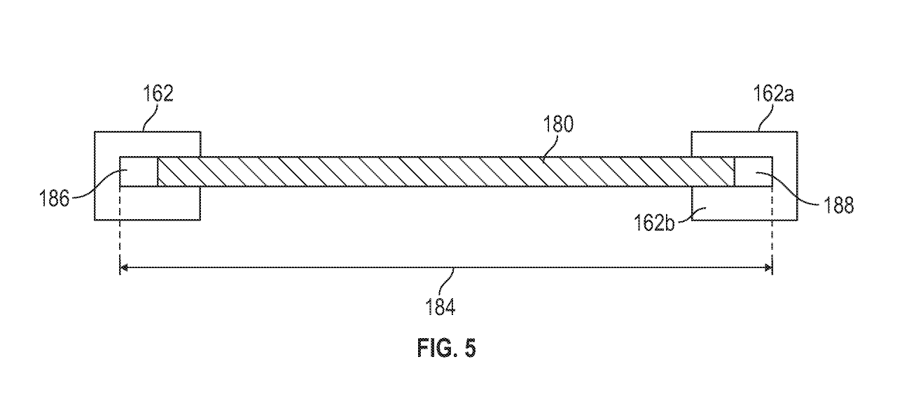

FIG. 5 illustrates a side view of the gripping members 162. The gripping members 162 can apply a compressive force to the flexible member 180. In at least one embodiment, the gripping member 162 comprises a first section 162a and a second section 162b. The first section 162a can be movable with respect to the second section 162b sufficient to grip the flexible member 180.

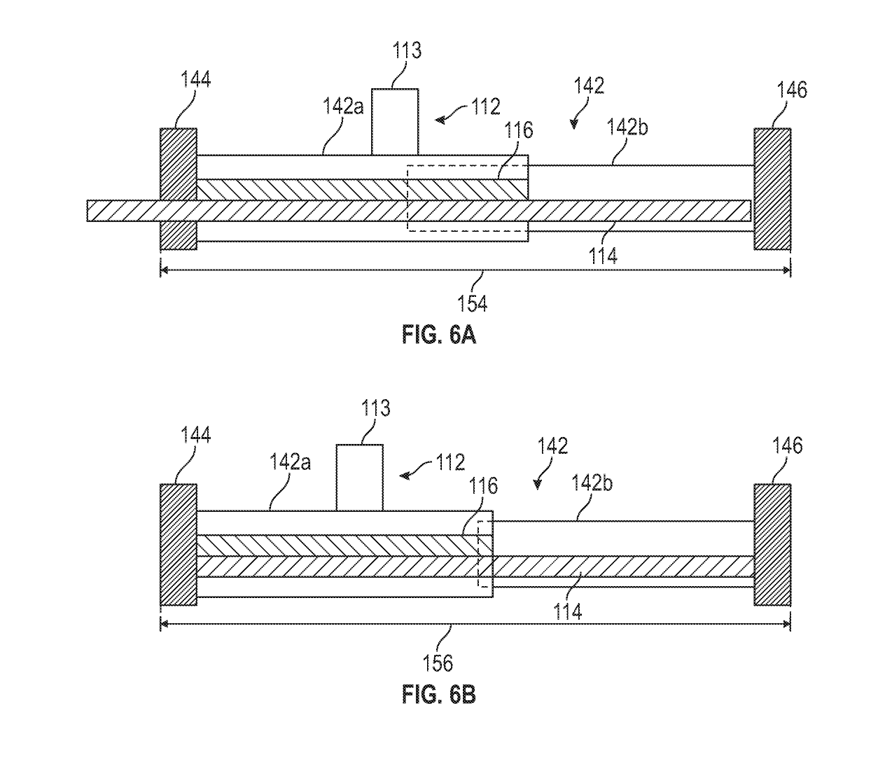

FIG. 6A-B illustrate the extended position and home position of the support members 142, and 144. As shown in FIGS. 6A-6B, the tensioning device 112 can be built into the support member 144.

FIG. 6A illustrates the home position of the support member 142. The support member 142 can have a first section 142a and a second section 142b. The first section 142a is shown slidably coupled to the second section 142b. The support member 142 can include a cavity formed from a body of the support member 142 sufficient to hold portions of the tensioning device 112. The first section 142a can be mechanically coupled to the support member 144 and the second section 142b can be mechanically coupled to the support member 146. The distance between the support members 144, 146 can be the longitudinal dimension 154.

The portion of the support member 142 (e.g., 142a) can be communicatively or mechanically coupled to the tensioning device 112. For example, the tensioning device 112 can further comprise a transfer mechanism/mechanical linkage 113 which is mechanically coupled to the drive component 114 and drive component 116. The transfer mechanism 113 can convert a rotational force from an electrical motor or manual device to linear motion sufficient to move support member 144. As shown, the tensioning device 112 is a screw-drive mechanism but a chain-drive mechanism is also contemplated. The drive components 114 and 116 are shown as rotating screw drive components, which may include a stoppage mechanism to prevent over tensioning.

As shown by FIG. 6B, in operation, rotational force from the transfer mechanism 113 can cause the screw drive component 114 to rotate and cause linear motion on support member 144 opposite from 146. The longitudinal dimension 154 of the support member 144 can increase to the longitudinal dimension 156. In at least one embodiment, the tensioning device 112 can be prevented from causing the first section 142a from separating from the second section 142b.

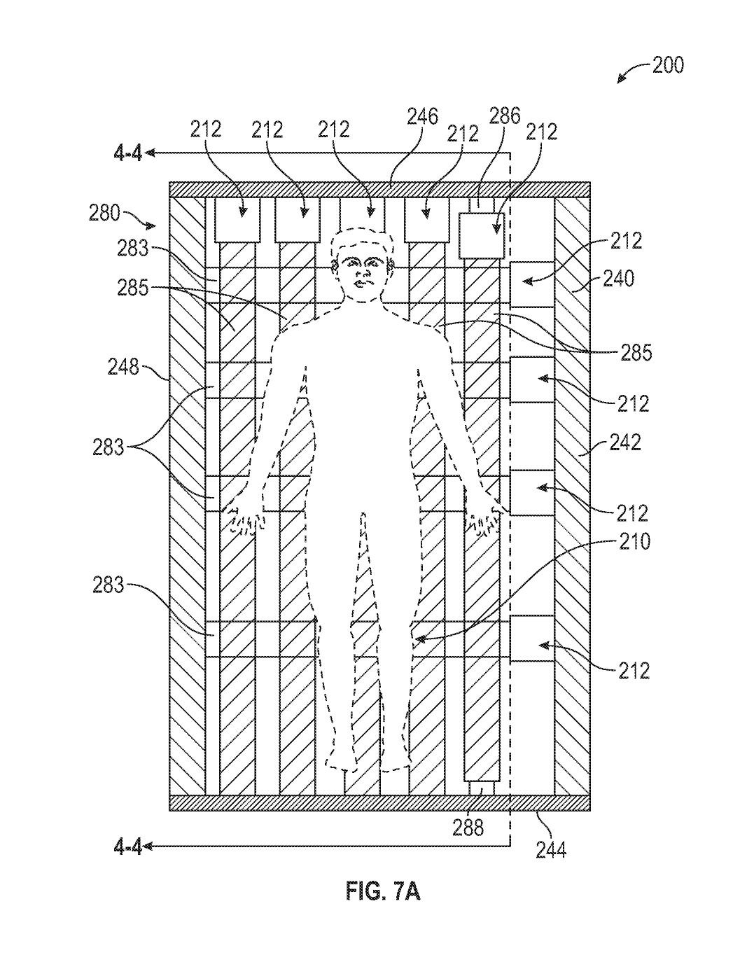

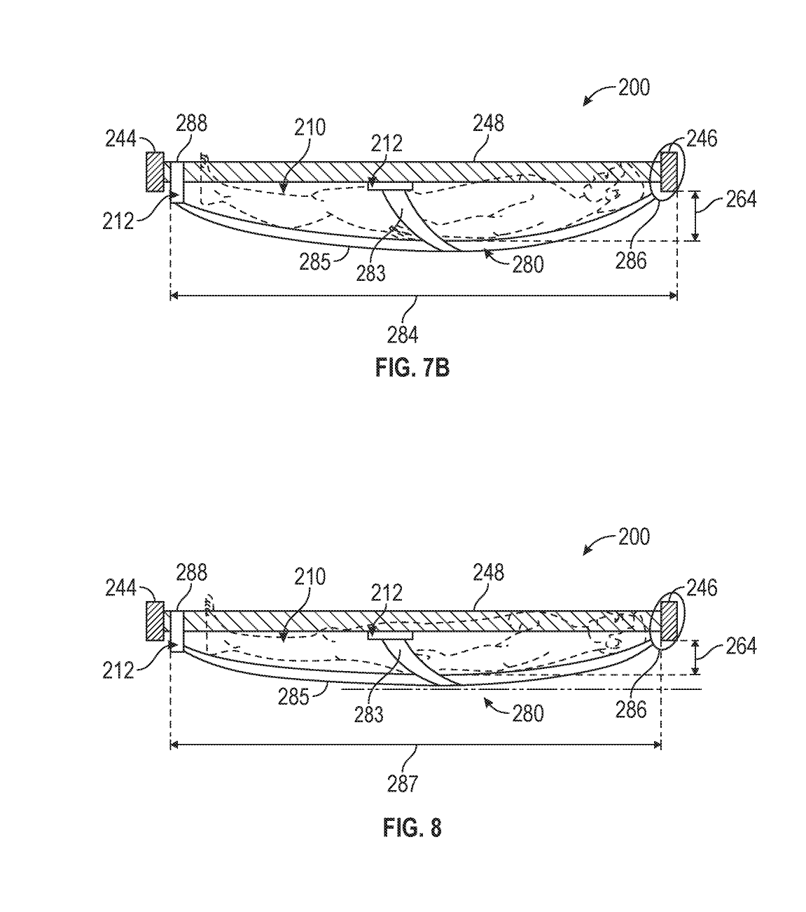

FIGS. 7-9 illustrate a patient moving system 200 similar to the patient moving system 100 in FIGS. 1-6 except that the support structure is generally fixed and the tension is provided by a tensioning device coupled to the flexible members. System 200 can use perpendicular, overlapping straps of woven material to create a high strength flexible member 280 that could support patients up to 300 lbs. In at least one embodiment, the material can be nylon because it has a high breaking strength and other moisture control properties that we desired. A silk or low friction cloth can also will be sewn to the underside of the straps to reduce transfer friction. Various layers can be used in conjunction with the flexible member 280 such as a cotton-based top sheet.

FIGS. 7A-B illustrate the patient moving system of 200. A bed is not shown. System 200 has a support structure 240, a flexible member 280, and a tensioning device 212.

The support structure 240 can be similar to the support structure 140 except that the support structure 240 is generally fixed in position. The support structure 240 can have members 242, 244, 246, and 248. The members 242 and 248 can run parallel with the anteroposterior axis of a patient 210. The members 244 and 248 can run perpendicular to the anteroposterior axis of a patient 210 and parallel to one another. The support structure 240 can form a general rectangular shape. An aspect of the support structure 240 is that the support members 246 and 244 are mechanically coupled to support members 242 and 248, respectively such that support members 246 and 244 do not more relative to one another. In at least one embodiment, a support member is arranged parallel to a width dimension defined by a mediolateral axis of the patient 210. At least one support member can be arranged parallel to a longitudinal dimension defined by the anteroposterior axis of a patient 210.

The flexible member 280 can comprise a plurality of straps. In at least one embodiment, straps of any durable material can be fixed, permanent or removable, to a portion of the support structure 240. Using this arrangement, straps can be cinched to a desired length and tension. When not in use they can then be placed to the side of the bed.

The plurality of straps can further include a plurality of longitudinal straps 285 and a plurality of width straps 283. In at least one embodiment, both the plurality of longitudinal (i.e., a set of) straps 285 and plurality of width (i.e., another set of) straps 283 can form a mesh. For example, at least one longitudinal strap 285 can interlace with the plurality of width straps 283 to form the mesh. In at least one embodiment, the width straps 283 can be oriented perpendicular to the longitudinal strap 285.

The flexible member 280 can include a strap 281 which includes at least two coupling elements 286, 288 fixed to the flexible member 280 at points outside of the central patient contact zone, wherein the plurality of coupling elements 286, 288 are constructed to attach the flexible member 280 to the support structure 240. The coupling elements 286 can be hooks, eyelets, loops, or combinations thereof. Coupling element 286 is shown as a loop for illustrative purposes whereas coupling element 288 is shown as a direct attachment to the support member 244.

A tensioning device 212 can be mechanically coupled to each strap. In at least one embodiment, the tensioning device 212 can be a self-ratcheting strap. Optionally, the tensioning device 212 can be mechanically coupled to a portion of the support structure 240. In at least one embodiment, a plurality of tensioning devices can be coupled to the longitudinal straps 285 and a second plurality of tensioning device can be coupled to the width straps 283. Thus, the second plurality of tensioning devices can be configured to tension the flexible member 283 along an axis perpendicular to the support member 242. In at least one embodiment, the second plurality of tensioning devices is mechanically coupled to support member 246.

In FIG. 7B, the longitudinal strap 285 and the width strap 283 can support the patient 210. The relaxed state of the flexible member 280 is determined by the length of the plurality of straps and has a longitudinal dimension 284. A given longitudinal dimension 284 corresponds to a height dimension 264. The height dimension 264 can be determined based on the difference between the nadir of the flexible member 280 and the plane when the flexible member 280 is tensioned (e.g., the midpoint of the support member 246).

In FIG. 8, the tensioned state of the flexible member 280 results in a shortening of the straps 285 and 283 which results in a shorter longitudinal dimension 287 which increases tension in the flexible member 280 and results in a raising of the patient according to the height dimension 264.

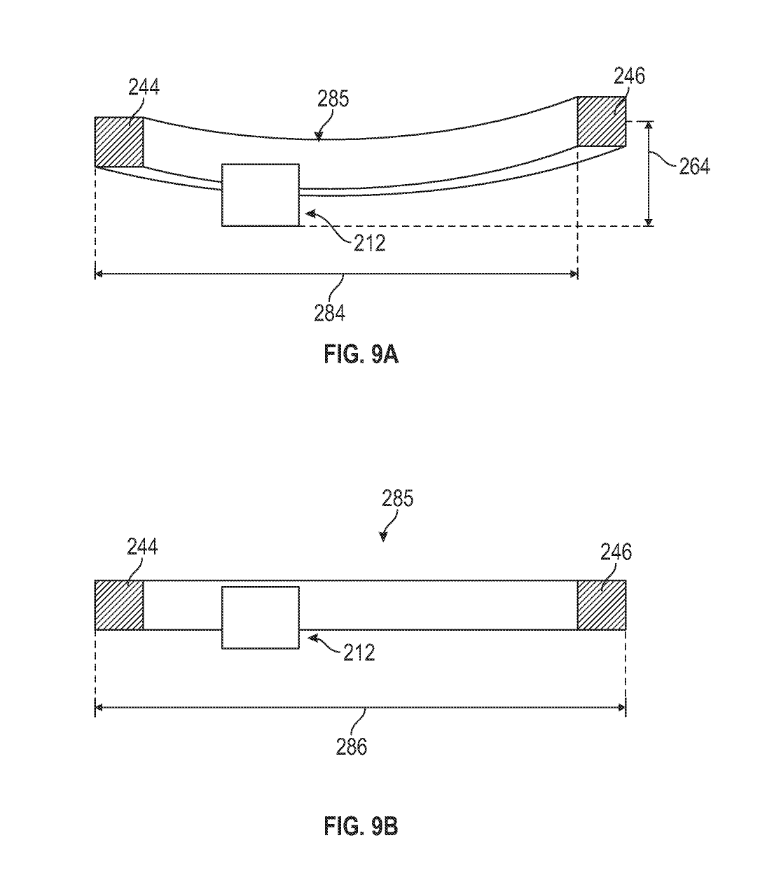

FIGS. 9A-9B illustrate a more detailed view of an embodiment of a longitudinal strap 285 in the relaxed and tensioned state. For example, the longitudinal strap 285 can form a loop around the support members 244 and 246. Tension caused by the tensioning device 212 can cause the length of the longitudinal strap 285 to shorten from longitudinal dimension 284 to longitudinal dimension 286 causing the patient to lift by height dimension 264.

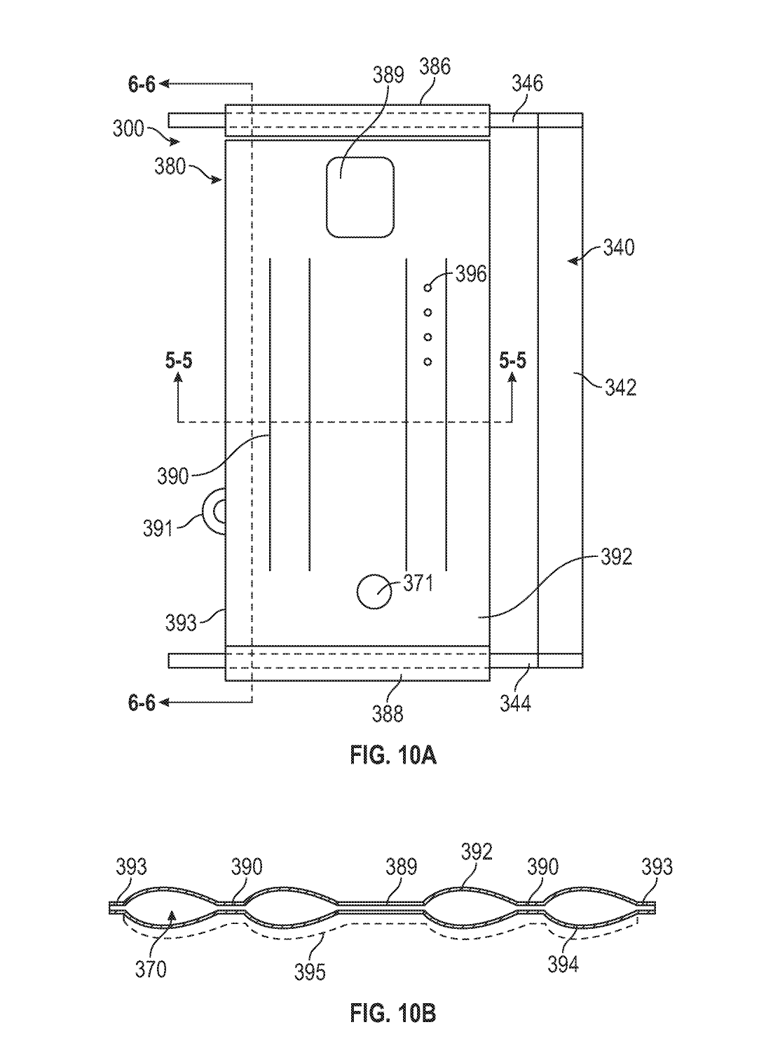

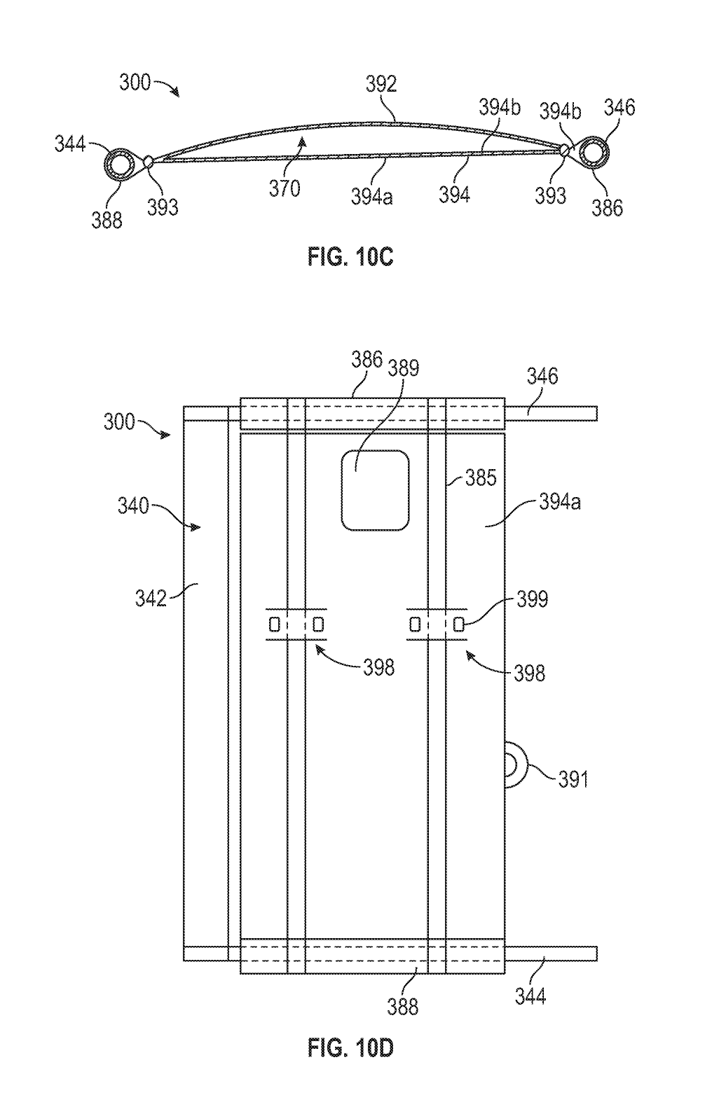

FIGS. 10A-10D illustrate an embodiment of a flexible member. The flexible member may also be configured for warming a patient in addition to transporting a patient. For example, the flexible member can resemble an underbody forced air blanket which is commercially available under the trade designation Bair Hugger and sold by 3M (St. Paul, Minn.) except that the bottom layer is reinforced to withstand tension and/or coated with a low-friction coating.

The system 300 can include a support structure 340. The support structure 340 may function similar to support structure 140 in FIGS. 1-5 except that the support structure 340 has only 3 support members 342, 344, and 346. The support members 344 and 346 can mechanically couple to support member 342 in a C or forked configuration. The support member 342 can be reinforced to withstand the tension without a fourth support member.

The system 300 includes flexible member 380. The flexible member 380 can be structured in multiple layers. The flexible member 380 includes a structure which has a first layer of material 394 and a second layer of material 392. The first layer of material 394 forms a bottom layer of the flexible member 380 and further has a tensile strength of at least 8 N/cm, at least 16 N/cm, at least 100 N/cm, at least 400 N/cm, at least 600 N/cm, at least 900 N/cm, at least 950 N/cm. Generally, a flexible member 380 above a 2000 N/cm may not provide additional benefits for patient transfer and may be overly cumbersome. The first layer 394 can be formed from any material but is preferably a non-woven. Suitable materials for the first layer 394 are described further herein. Further, the first layer 394 can be further strengthened with reinforcing filaments embedded therewith.

In FIG. 10B, the second layer of material 392 forms an upper layer of a warming blanket. The upper layer 392 allows a profusion of air to pass through the upper layer, the upper layer coupled to the bottom layer 394 around a periphery 393 of the bottom layer 394 to form an initial shape and to form an interior space 370 between the first layer of material 394 and the second layer of material 392. The interior space 370 comprises a plurality of interconnected air passageways, wherein the passageways are defined by a plurality of seals 390 formed between the upper layer and the bottom layer within an area defined by the periphery 393.

Optionally, the first layer 394 can incorporate a low-friction material 395 (such as a coating, applied material, or inherently low-friction material), disposed on the bottom face of the first layer 394. In order to reduce the lateral force needed to move a patient, transfer would be achieved by using a bottom sheet made from a material that has a low friction coefficient. Preferably, the low-friction material layer would be soft and either single-patient use disposable or machine washable so it would able to stay on the bed with the patient.

In FIG. 10A, the flexible member 380 has an inlet 371 located on the upper layer 392. The inlet 371 includes inlet passageway configured to receive a flow of air from a source and to provide the flow of air to the plurality of interconnected air passageways 370.

The flexible member 380 also has a plurality of perforations 396 formed from the first layer 394 sufficient for air to flow through a patient.

The first layer 394 and second layer 392 can be heat sealed together. For example, the periphery 393 of the flexible member 380, the seals 390, and the periphery of the head portion 389 can be heat sealed sufficient to prevent the flow of air from escaping except through the plurality of perforations 396.

An optional handle 391 can also be mechanically coupled to or formed with the first layer 394 to provide additional support. The one or more handles 391 can generally be disposed outside of the periphery 393.

In FIG. 10C, coupling elements 386 and 388 are shown. Coupling elements 386, 388 can secure the flexible member 380 to the support structure 340. For example, the coupling elements 386, 388 can slide over the support members 344, 346 (when the flexible member 380 is loaded toward the member 342) without the need for clamps on the support structure 340.

The coupling elements 386, 388 can be formed as a loop having an inner surface configured to contact a portion of the support structure. In at least one embodiment, the first layer 394 has an inner surface 394b and an outer surface 394a, wherein the loop is formed from an end portion of the inner surface 394b contacting a portion of the inner surface 394b and mechanically coupled. The loop can be further coupled together at the periphery 393 using a heat seal.

The loops 386, 388 can be withstand tension. For example, the first layer 394 and the loops 386, 388 can be capable of withstanding a static load of a 300 lb. patient when suspended from the first loop 386 and the second loop 388.

In FIG. 10D, the bottom face 394a is shown. The flexible member 380 can have one or more longitudinal straps 385 disposed thereon. The straps 385 can be embedded therein or laying upon the first layer 394. The straps 385 can provide the first layer 394 with additional structural elements sufficient so that the first layer 394 does not tear or stretch. The straps 385 can be further secured by mechanical loops 398 that function to reduce lateral movement of the longitudinal straps 385 or ensure that certain areas of the patient are secure. The loops 398 can be mechanically secured to the first layer 394 by heat seals 399.

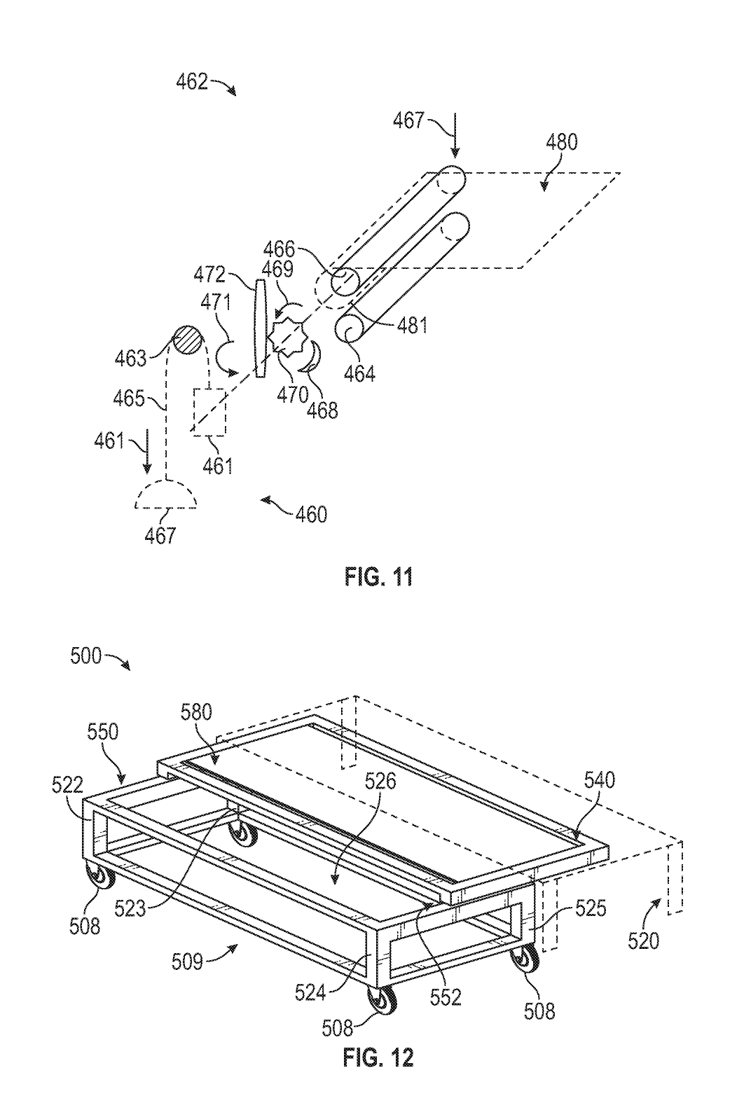

FIG. 11 illustrates an embodiment of a gripping member 462. The gripping member 462 can be an embodiment of the gripping member 162 in FIGS. 1-5. The gripping member 462 can use rollers and an optional pulley system to secure a flexible member 480 and also apply tension to the flexible member 480.

The gripping member 462 can have at least two rollers, roller 466 and roller 464. At least one of the rollers can be rotated manually. In some embodiments, one roller may also roll freely. On the mating surfaces of each of the rollers 464, 466 may be interlocking serrated teeth used to securely grab fabric or a portion of flexible member 480. In some embodiments, teeth may be lined with a non-slip material, such as rubber, or other similar coating, or may be textured, such as with groves or other surface features, to prevent linen slippage. In other embodiments, non-serrated bars may also be effective in supporting patients in excess of 200 lbs.

As shown, the roller 466 can be advanced downward according to arrow 467. The roller 466 can also be rotated according to arrow 469. A leading edge 481 of the flexible member 480, can be fed into the roller 466 (e.g., around a portion of the circumference of roller 466). As downward force is applied, rotational force is also applied causing the flexible member to advance through the rollers 464, 466 and become tensioned.

At least one of the rollers 464 can be connected to the gear assembly 470. As the gear assembly rotates in direction 469, a stoppage mechanism 468 may engage each tooth of the gear assembly in order to prevent unintentional release of tension. A lever 472 can facilitate the downward motion 467 or the rotational motion 471 of the roller 466.

In at least one embodiment, the downward motion 467 or rotational motion 471 can also be facilitated by a pulley system 460. The pulley system 460 can translate downward motion 461 from a stomping motion into rotational or downward motion of the roller 466 by one or more pulleys. Instead of bending at the waist and using the lower back and arms to lift and move the patient, a caregiver would use a stepping motion. To achieve this stepping motion, a pulley system 460 can be used. The pulley system 460 is used to change the direction of the force and to reduce the force necessary to move an object. The pulley system 460 can be created by attaching cables 465 with a stirrup 467 to one or more pulleys 463 and to a transfer box 461. The transfer box 461 could translate the linear force into a rotational force and transfer the force to the roller 466. The pulleys 463 could be detachable to achieve the appropriate leverage.

In FIG. 12, a patient moving system 500 is shown. The patient moving system 500 can be similar to patient moving system 100 in FIGS. 1-5 except that the patient moving system 500 is not releasably coupled to the bed 520 and is instead mounted on a movable cart 509.

The cart 509 can have support columns 522, 523, 524, and 525. The support columns can be attached to a base 526. The base 526 may support a portion of the support structure 540 which further supports the flexible member 580. The base 526 may have sliding mechanisms 550 and 552 which are similarly configured to sliding mechanisms 150 and 152 in FIGS. 1-5. The support columns 522, 523 are attached to the base 526 at the end corresponding to sliding mechanism 550 while the support columns 524, 525 are attached to the base 526 at the end corresponding to sliding mechanism 550. Each of the support columns may be coupled to one or more wheels (e.g., caster wheels) 508.

In at least one embodiment, a portion of the sliding mechanism 550 can be coupled to a support column 522, 523, 524, or 525, or base 526.

In at least one embodiment, the base 526 is generally rectangular in shape when viewed from above. The base 526 is constructed of any durable material, preferably a fairly dense wood, metal or metal alloy such as stainless steel to help anchor the device. Four wheels or pivoting casters 508 are attached to the base 526 or support columns, one at each corner, and provide a clearance space of about three inches between the bottom of the cart 509 and the floor. Casters 508 are preferably large-diameter, low-rolling resistance and have locking mechanisms or brakes to keep base 526 stationary during a loading or unloading operation. Alternately, it may be desirable to lower four locking posts (having rubber feet and located at each corner) down onto the floor from base 526, slightly lifting the wheels off the floor; the posts then rigidly hold the unit in position during lifts and transfers. The rear wheels may be fixed with front casters to facilitate pushing cart 509 in a manner similar to a grocery cart. A suspension system can optionally be installed between the column and the wheels for smoother transportation of the patient.

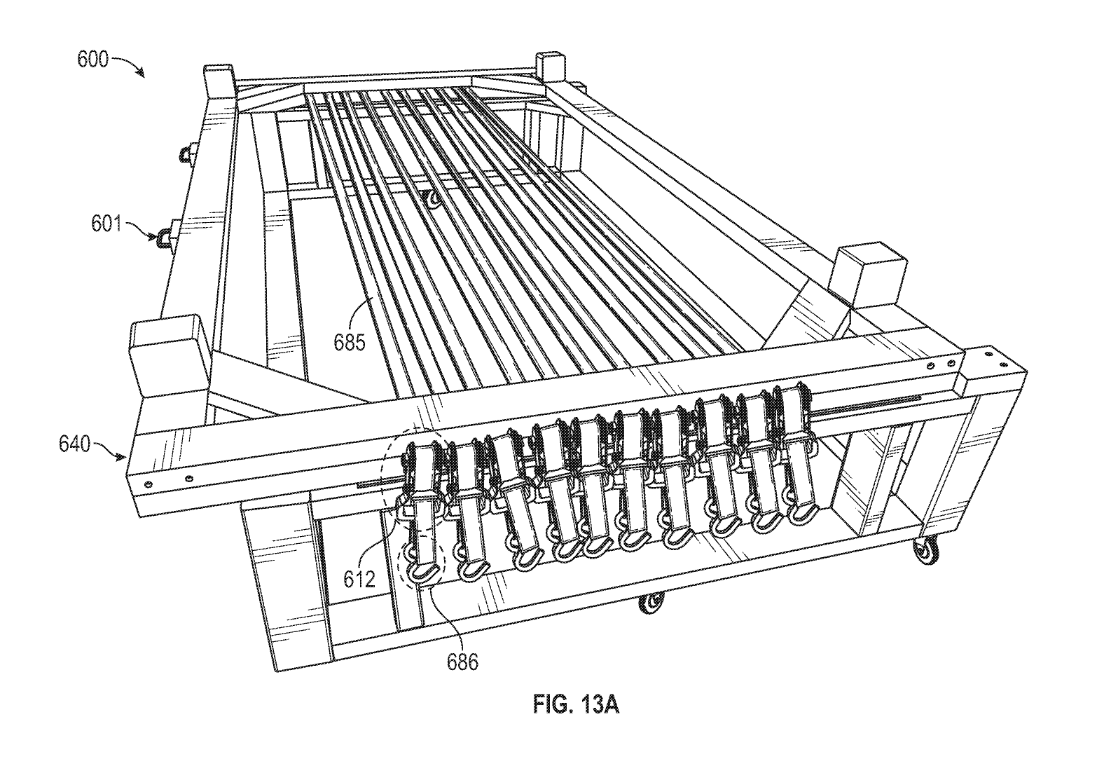

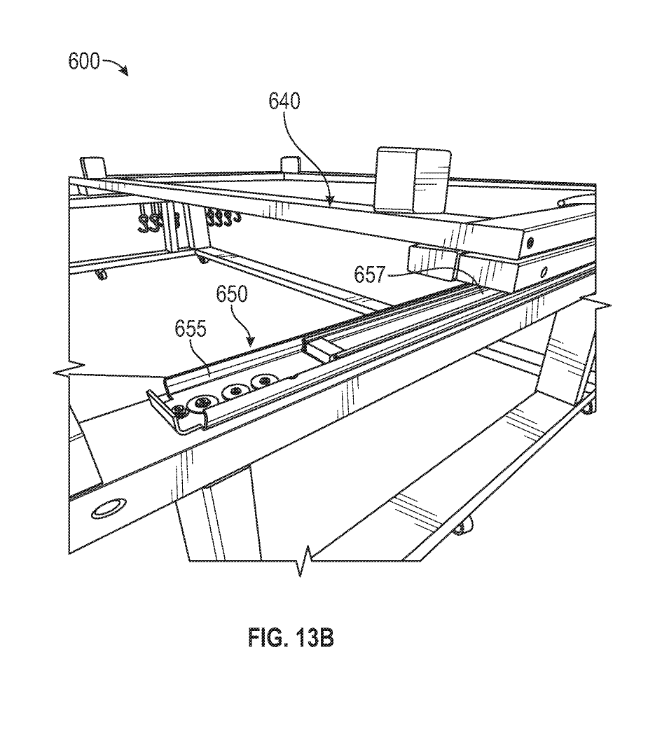

FIG. 13A-B illustrate a patient moving system 600. The patient moving system 600 can be similar to the patient moving system 200 in FIGS. 7-9 except the sliding mechanism 650 is shown and is mounted to the bottom of the support structure 640. The sliding mechanism 650 can have a carriage 655 and slide frame 657. The longitudinal strap 685 can also have a tensioning device 612 coupled therewith and a coupling element 686 (shown as a hook).

The system 600 can be releasably coupled to the head and foot of a bed as shown in FIG. 12. In at least one embodiment, the system 600 can use a mesh as a basis for creating a flexible member by attaching two strong nylon straps to the support structure. Then, the nylon straps 685 are fed into the ratcheting rollers 612 which are connected to the sliding mechanisms e.g., 650, at the top and bottom ends of the bed. The ratcheting rollers 612 can be used to create tension across the support structure to lift the patient slightly above the bed. Once proper tension is achieved, the sliding mechanism 650, formed from the combination of the rails 657 at the head and foot of the bed, can be pulled out using a handle 601 that is fixedly coupled to the support structure 640 to transfer the patient from one surface to the other. These rails 657 are strong enough to hold a person's weight at full extension. Once the patient has been transferred, the tension in the modified bed sheet is released and the patient is lowered back down. The sliding mechanism could then be pushed back into its casing and the transfer would be complete.

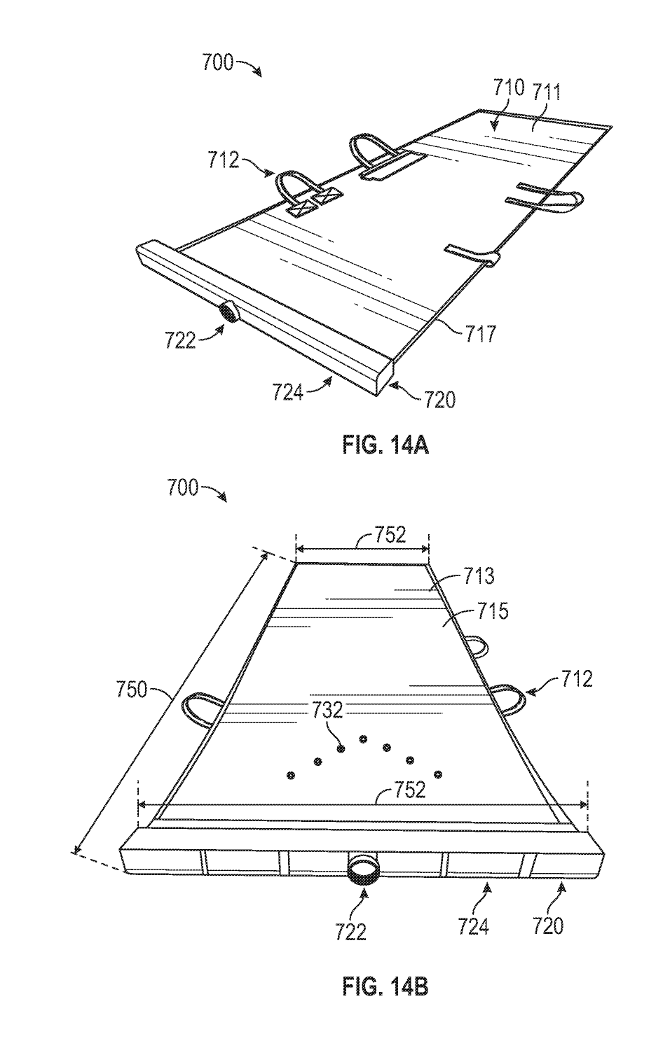

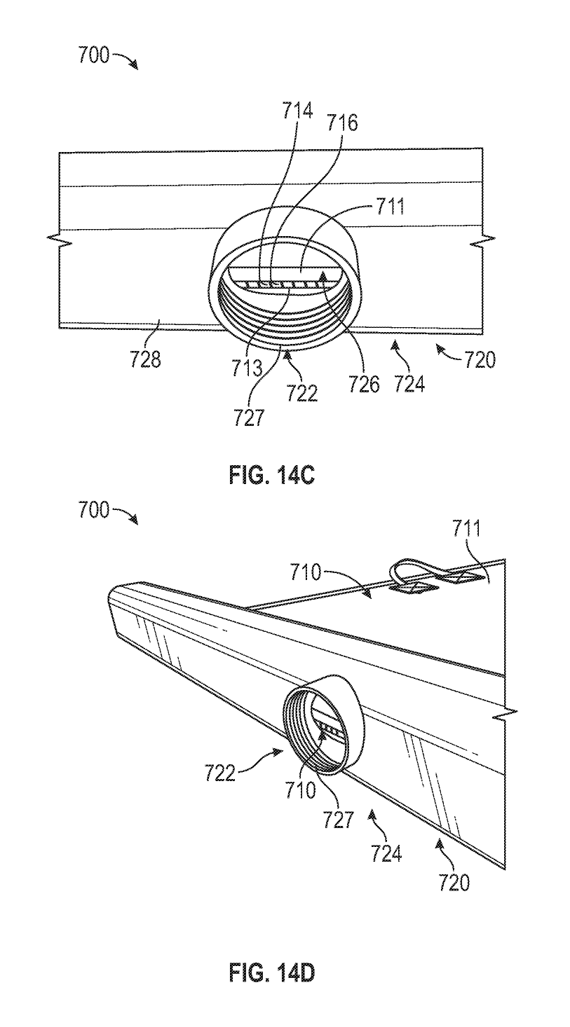

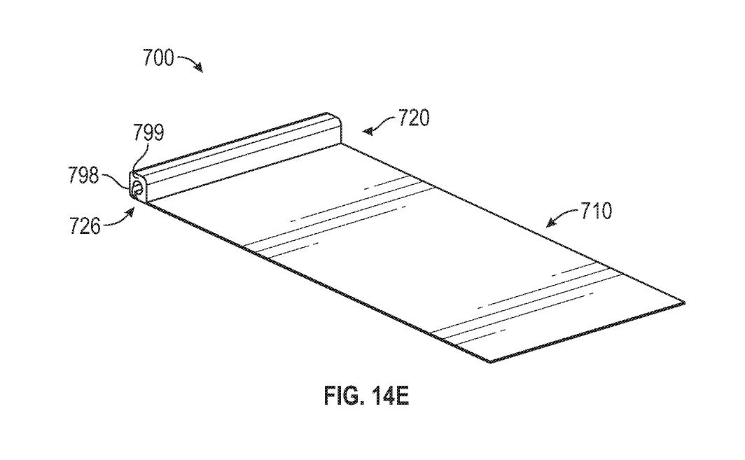

FIGS. 14A-E illustrate a patient moving system 700. The patient moving system 700 uses forced air pressure dispersed through a bottom layer of corrugated plastic board to move a patient.

The system 700 can include a corrugated plastic board 710. The corrugated plastic board 710 is made from a plastic such as polypropylene, polycarbonate, or vinyl and is commercially available under the trade designation Corruboard by Demco (Madison, Wis.).

The corrugated plastic board 710 can include a first layer 711 and a second layer 713. The second layer 713 and the first layer 711 can have a plurality of support columns 714 which are contact both the first layer 711 and the second layer 713. A plurality of channels 716 can be formed from at least two support columns 714 and the first layer 711 and the second layer 713.

Exemplary dimensions of the channel 716 have a support column height of at least 5.5 mm and a distance between support columns 714 of at least 4 mm. To help reduce the amount of head loss in the system, it can be preferable to use a support column height of at least 10 mm and a distance between support columns 714 of at least 10 mm. This would reduce the amount of friction between the air and the channels as it passes through the corrugated plastic board 710. In at least one embodiment, the support column 714 can have a wall thickness sufficient to keep altered channels from collapsing when weight is placed on them. In at least one embodiment, the material thickness is at least 0.1 mm, at least 0.5 mm, or at least 1 mm.

The corrugated plastic board 710 can also have a plurality of perforations 732 formed within the second layer 713, specifically within the outer surface 715 of the layer 713. The perforations 732 can be spaced evenly throughout the second layer 713 to form an even distribution of air. At least some of the perforations 732 are fluidically coupled to at least some of the channels 716.

The system 700 also includes a fluidic manifold 720. The fluidic manifold 720 can have an inlet 722 and a major portion 724. The major portion 724 can be formed from at least one layer of material 728 thereby forming a chamber 726.

In FIG. 14E, the major portion 724 is formed from a single piece of 3D printed material. The major portion 724 is generally C-shaped. The major portion 724 can form a chamber 726 across the entire width dimension of the manifold 720. The chamber 726 has a tear-drop shaped cross-section with a major portion 799 and a tapering portion 798 that tapers into the plurality of channels 716. In various embodiments, the tapering portion 798 can contact the outer surface 715 on layer 713. The chamber 726 is fluidically coupled to the plurality of channels 716 and can receive a fluid (e.g., air) from the inlet 722 and distribute the air into the plurality of channels 716.

The inlet 722 is configured to receive a fluid from a fluidic source such as an air blower. The inlet 722 may further have threading 727 to facilitate attachment to a hose from an air blower. In at least one embodiment, the chamber 726 may have one or more baffles (not pictured) mechanically coupled to the inner portion of the layer 728.

The system 700 can have a periphery 717 which defines the boundaries of the corrugated plastic board 712 and the manifold 720. The handles 712 can extend past the periphery 717. The system 700 can have longitudinal dimension 750 and width dimensions 752. As shown, the width dimensions 752 are the same for both ends of the system 700 and the system 700 is generally rectangular and corresponds in size to a patient.

In at least one embodiment, the fluidic manifold is a 3D-printed guide with a slot formed therein where a corrugated plastic board 710 is inserted. In at least one embodiment, the corrugated plastic board 710 that has a bottom 713 and top layer 711 of plastic with individual parallel channels 716 supporting the structure in between. The channel 716 design provides strength, and it allows air to pass through the length of the board.

In use, once the high pressure air enters the channels 716, the air can be funneled out of perforations 732 formed in the bottom layer 713 therein. The escaping air causes the corrugated plastic board 710 to float on a pocket of air which can allows a patient to be transferred with minimal friction.

In at least one embodiment, trays containing wheels or ball bearings can be attached to the hospital bed. In use, the patient would lay on a piece of padded plastic board 710 wherein a padded layer is disposed to the outer surface of 711. A drawer that is attached to the gurney by trays of wheels would be extended and the patient would be slightly lifted to rest on top the tray. The tray would then be slid by pulling on handles attached to the tray frame. Next, the patient would be wheeled to their new location. When the patient is at the new location and need to be transferred into the bed or onto the table, the drawer would be extended. Then, the system 700 could be lifted slightly and the frame could be slid beneath the system 700 to return to its initial position.

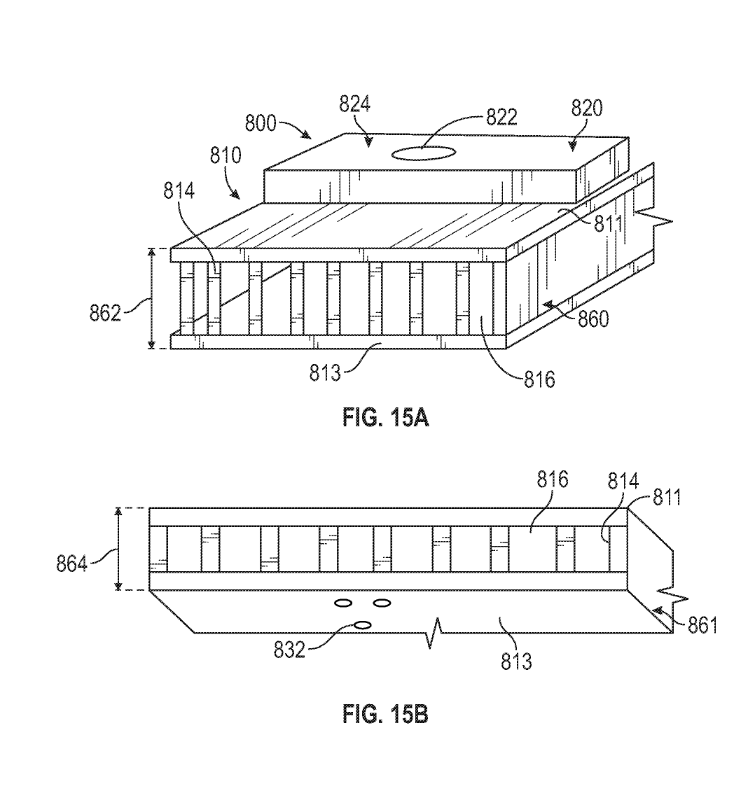

FIGS. 15A-15B illustrate a patient moving system 800 which is another embodiment of system 700 in FIG. 14 and has similarly numbered components. System 800 has the manifold 820 on the top of the corrugated plastic board 810 and the structure of the corrugated plastic board 810 is tapered. For illustrative purposes, a face of the channel 816 is left exposed, however, in use the face of the channels 816 would be covered.

System 800 has a fluidic manifold 820 with a portion 824 and an inlet 822. The manifold 820 is mounted on the top of the board 810 which allows the bottom layer 813 to have full contact with a transfer surface. Specifically, the manifold 820 can contact the layer 811 and openings within the layer 811 (not shown) can fluidically couple with the channels 816.

The board 810 can differ from the board 710 in that the board 810 is tapered. For example, the support columns 814 can have a greater height dimension 862 at a first end 860, than the height dimension 864 at a second end 861. In at least one embodiment, the fluidic manifold 820 can be positioned at end 860 to increase the air speed exiting perforations 832 toward end 861. Aspects of this embodiment may create an even pocket of air that reduces the potential of a drag point.

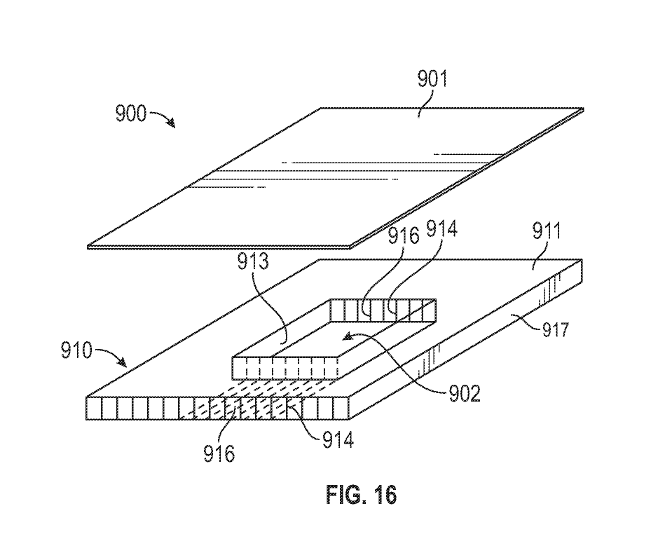

FIG. 16 illustrates a portion of a patient moving system 900 which is another embodiment of the corrugated plastic board 710 in FIG. 14 and has similarly numbered components. System 900 can use either the side-mounted manifold 720 configuration in FIG. 14 or the top-mounted manifold 820 configuration in FIG. 15. The manifold in FIG. 16 is not shown. For illustrative purposes, a face of the channel 616 is left exposed, however, in use the face of the channels 816 would be covered.

The system 900 can have a corrugated plastic board 910 which is similar to corrugated plastic board 710 except that corrugated plastic board 910 has a hole 902 formed therein. The hole 902 can be formed from an absence in the layer 911, layer 913 and a portion of a plurality of support columns 914. At least one of the channels 916 can open into the hole 902. In at least one embodiment, the hole can have at least one dimension that is at least 4 inches. The hole 902 can be formed within the periphery 917 of the plastic board 910.

The system 900 can further include a second corrugated plastic board 901 to be placed over the hole 902. For example, a portion of the corrugated plastic board 901 can contact a portion of layer 911. In use, air can migrate through the channels 916 to form a pocket of air in the hole 902 which would reduce the contact area of the system 900 on a transfer system.

### LIST OF ILLUSTRATIVE EMBODIMENTS

### Embodiment 1

A patient moving system, comprising:
a support structure comprising:
a first support member;
a second support member and a third support member, the second support member is arranged parallel to the third support member;

a flexible member removably attached to the second support member and the third support member;

a tensioning device mechanically coupled to at least the flexible member and configured to provide tension to the flexible member.

### Embodiment 2

The patient moving system of embodiment 1, wherein the support structure comprises

a longitudinal dimension corresponding to an anteroposterior axis of a patient; and

a width dimension corresponding to a mediolateral axis of the patient.

### Embodiment 3

The patient moving system of embodiment 1 or 2, wherein the first support member is arranged parallel to the longitudinal dimension.

### Embodiment 4

The patient moving system of embodiment 3, wherein the second support member is arranged parallel to the width dimension.

### Embodiment 5

The patient moving system of embodiment 1 or 2, wherein the first support member is arranged parallel to the width dimension.

### Embodiment 6

The patient moving system of embodiment 5, wherein the second support member is arranged parallel to the longitudinal dimension.

### Embodiment 7

The patient moving system of any of embodiments 1 to 6, wherein the second support member is coplanar with the third support member.

### Embodiment 8

The patient moving system of any of embodiments 1 to 7, wherein first support member is coplanar with the second support member.

### Embodiment 9

The patient moving system of any of embodiments 1 to 8, wherein the tensioning device tensions the flexible member along an axis parallel to the first support member.

### Embodiment 10

The patient moving system of any of embodiments 1 to 9, wherein the tensioning device is a ratchet system.

### Embodiment 11

The patient moving system of any of embodiments 1 to 10, further comprising:

a first slide frame having a first end and a second end;

a second slide frame having a first end and a second end;

a first carriage having a first end slidably supported by the first slide frame, movable between a first extended position wherein the first end of the first carriage is between the first end and the second end of the first slide frame, and a home position wherein the first end of first slide frame is aligned with the first end of the first carriage;

a second carriage having a first end slidably supported by the second slide frame, movable between a first extended position wherein the first end of the second carriage is between the first end and the second end of the first slide frame, and a home position wherein the first end of first slide frame is aligned with the first end of the first carriage;

wherein at least a portion of the support structure is mechanically coupled to a portion of the first carriage and a portion of the second carriage.

### Embodiment 12

The patient moving system of embodiment 11, wherein the first slide frame and second slide frame is attached to a base having a plurality of wheels or bearings,

a first support column attached to the base at a first end thereof;

a second support column attached to the base a second end thereof;

the first slide frame attached to the first support column; and

the second slide frame attached to the second support column.

### Embodiment 13

The patient moving system of any of embodiments 1 to 12, wherein the tensioning device is mechanically coupled to a portion of the support structure.

### Embodiment 14

The patient moving system of any of embodiments 1 to 13, wherein the tensioning device is mechanically coupled to the first support member.

### Embodiment 15

The patient moving system of any of embodiments 1 to 14, wherein first support member comprises a first section and a second section, wherein the first section is slidably coupled to the second section.

### Embodiment 16

The patient moving system of embodiments 14 or 15, wherein at least the first section is mechanically coupled to the tensioning device.

### Embodiment 17

The patient moving system of any of embodiments 14 to 16, wherein at least the first section and the second section is mechanically coupled to the tensioning device.

### Embodiment 18

The patient moving system of any of embodiments 1 to 17, wherein tensioning device comprises an electrical motor, electric actuator, or pneumatic actuator.

### Embodiment 19

The patient moving system of any of embodiments 1 to 18, wherein tensioning device comprises a screw-drive mechanism.

### Embodiment 20

The patient moving system of any of embodiments 1 to 19, wherein tensioning device comprises a chain-drive mechanism.

### Embodiment 21

The patient moving system of any of embodiments 1 to 20, wherein tensioning device comprises a mechanical linkage to provide tension from the second support member and the third support member.

### Embodiment 22

The patient moving system of any of embodiments 1 to 20, wherein tensioning device comprises a stoppage mechanism to prevent over tensioning.

### Embodiment 23

The patient moving system of embodiment 22, wherein the stoppage mechanism comprises a ratchet system to prevent unintentional release of tension.

### Embodiment 24

The patient moving system of any of embodiments 1 to 23, wherein the tensioning device allows uniform tensioning of the flexible member between the third support member and the second support member.

### Embodiment 25

The patient moving system of any of embodiments 1 to 24, wherein the tensioning device comprises a lever mechanism.

### Embodiment 26

The patient moving system of any of embodiments 1 to 25, wherein the tensioning device comprises a gear assembly.

### Embodiment 27

The patient moving system of any of embodiments 1 to 26, wherein the first support member is mechanically coupled to the second support member and the third support member.

### Embodiment 28

The patient moving system of any of embodiments 1 to 27, wherein the support structure further comprises a fourth support member parallel to the first support member.

### Embodiment 29

The patient moving system of embodiment 28, wherein the support structure is a generally rectangular shape.

### Embodiment 30

The patient moving system of any of embodiments 1 to 29, further comprising a second tensioning device configured to tension the flexible member along an axis perpendicular to the first support member.

### Embodiment 31

The patient moving system of embodiment 30, wherein the second tensioning device is mechanically coupled to the second support member, wherein the second support member comprises a first section slidably coupled to a second section, wherein the second tensioning device causes and end of the first section to slide away from an end of the second section.

### Embodiment 32

The patient moving system of any of embodiments 1 to 31, further comprising a gripping member mechanically coupled to at least a portion of the support structure, wherein the gripping member is configured to compress a portion of the flexible member to cause sufficient friction to prevent the flexible member from slipping.

### Embodiment 33

The patient moving system of embodiment 32, wherein the gripping member is a clamp.

### Embodiment 34

The patient moving system of embodiment 32, wherein the gripping member is a hook.

### Embodiment 35

The patient moving system of any of embodiments 1 to 34, wherein the flexible member comprises a first set of one or more straps oriented parallel to an axis formed by the first support member.

### Embodiment 36

The patient moving system of embodiment 35, wherein the flexible member comprises a second set of one or more straps oriented perpendicular to the first set.

### Embodiment 37

The patient moving system of embodiment 36, wherein the first set and second set of one or more straps form a mesh.

### Embodiment 38

The patient moving system of any of embodiments 1 to 37, wherein the flexible member comprises a fabric.

### Embodiment 39

The patient moving system of any of embodiments 1 to embodiment 37, wherein the flexible member comprises a non-woven.

### Embodiment 40

The patient moving system of embodiment 38, wherein the fabric is woven or knitted.

### Embodiment 41

The patient moving system of embodiment 38 or embodiment 39, wherein the fabric or non-woven is instantaneously absorbent to water.

### Embodiment 41a

The patient moving system of embodiment 41, wherein the fabric further comprises a barrier film to ensure that liquids do not pass through the fabric.

### Embodiment 42

The patient moving system of any of embodiments 1 to 38, wherein the flexible member comprises a polymeric film.

### Embodiment 43

The patient moving system of any of embodiments 1 to 42, wherein the flexible member further comprises reinforcing filaments.

### Embodiment 44

The patient moving system of any of embodiments 1 to 43, wherein the flexible member is a sheet.

### Embodiment 45

The patient moving system of embodiment 44, wherein the flexible member further comprises a central patient contact zone.

### Embodiment 46

The patient moving system of embodiment 44 or embodiment 45, wherein the flexible member further comprises at least two coupling elements fixed to the flexible at points outside of the central patient contact zone, wherein the plurality of coupling elements are constructed to attach the flexible member to the support structure.

### Embodiment 47

The patient moving system any of embodiments 44 to 46, wherein the flexible member is able to support a weight of at least 75 kilograms.

### Embodiment 48

The patient moving system any of embodiments 44 to 47, wherein the flexible member has a length along the longitudinal dimension of at least 170 cm and a width along the width dimension of at least 70 cm;

### Embodiment 49

The patient moving system of any of embodiments 1 to 48, wherein the coupling element comprises an area of high-friction.

### Embodiment 50

The patient moving system of embodiment 49, wherein the coupling element is a loop having an inner surface configured to contact a portion of the support structure.

### Embodiment 51

The patient moving system of any of embodiments 1 to 50, wherein the flexible member is an underbody patient warming blanket comprising:

a structure comprising a first layer of material and a second layer of material,

the first layer of material forming a bottom layer of the flexible member, and

the second layer of material forming an upper layer of a warming blanket, the upper layer configured to allow a profusion of air to pass through the upper layer, the upper layer coupled to the bottom layer around a periphery of the bottom layer to form an initial shape and to form an interior space between the first layer of material and the second layer of material comprising a plurality of interconnected air passageways, wherein the plurality of interconnected air passageways are defined by a plurality of seals formed between the upper layer and the bottom layer within an area defined by the periphery;

an inlet located on the upper layer or the bottom layer, the inlet comprising an inlet passageway configured to receive a flow of air from a source and to provide the flow of air to the plurality of interconnected air passageways.

### Embodiment 52

The patient moving system of any of embodiments 1 to 51, wherein the flexible member has a tensile strength of 2 MPa to 35 MPa (inclusive).

### Embodiment 53

The patient moving system of any of embodiments 1 to 52, wherein the flexible member has a tensile strength of 6 MPa.

### Embodiment 54

The patient moving system of any of embodiments 1 to 53, wherein the flexible member has a tensile strength of at least 8 N/cm.

### Embodiment 55

The patient moving system of embodiment 54, wherein the flexible member has a tensile strength of at least 12 N/cm.

### Embodiment 56

The patient moving system of embodiment 55, wherein the flexible member has a tensile strength of at least 16 N/cm.

### Embodiment 57

The patient moving system of embodiment 55, wherein the flexible member is nylon.

### Embodiment 58

The patient moving system of embodiment 55, wherein the flexible member has a low-friction coating disposed thereon.

### Embodiment 59

A system comprising:

the patient moving system of any of embodiments 1 to 58;

a bed having a first end and a second end,

at least a portion of the first slide frame is mechanically coupled to the first end of the bed; and

at least a portion of the second slide frame is mechanically coupled to the second end of the bed.

### Embodiment 60

A method of moving a patient, comprising:

sliding the flexible member of the patient moving system of any embodiments 1 to 59 under a patient;

attaching the flexible member to the second support member and the third support member; and

applying tension to the flexible member by moving the second support member laterally and in an opposite direction from the third support member; wherein a tensile force is at least 3700 N;

allowing the patient to move from a first height to a second height.

### Embodiment 61

The method of embodiment 60, further comprising:

applying a lateral force sufficient to move the patient to a first extended position along the first and second slide frame.

### Embodiment 62

The method of embodiment 60 or 61, further comprising:

reducing tension to the flexible member by moving the second support member toward the third support member,

allowing the patient to move from the second height to the first height.

### Embodiment 62a

The method of embodiment 60 or 61, further comprising:

reducing tension to the flexible member by moving the second support member toward the third support member,

allowing the patient to move from the second height to a third height corresponding to a new support surface.

### Embodiment 63

The method of any of embodiments 60 to 62, wherein the applying tension occurs by sliding a first end of a first section of the first support member away from the first end of the second section of the second support member.

### Embodiment 64

The method of any of embodiments 60 to 63, wherein the applying tension occurs through a manual device.

### Embodiment 65

The method of embodiment 64, wherein the manual device is a hand crank, a ratchet system, or a pulley.

### Embodiment 66

The method of any of embodiments 60 to 65, further comprising

attaching the flexible member to the first support member and the fourth support member; and

applying tension to the flexible member by moving the first support member laterally and in an opposite direction from the fourth support member; wherein the tensile force is at least 3700 N;

allowing the patient to move from a first height to a second height.

### Embodiment 67

A warming blanket, comprising:

a structure comprising a first layer of material and a second layer of material, the first layer of material forming a bottom layer having a tensile strength of at least 8 N/cm, and

the second layer of material forming an upper layer of the warming blanket, the upper layer configured to allow a profusion of air to pass through the upper layer, the upper layer coupled to the bottom layer around a periphery of the bottom layer to form an initial shape and to form an interior space between the first layer of material and the second layer of material comprising a plurality of interconnected air passageways, wherein the passageways are defined by a plurality of seals formed between the upper layer and the bottom layer within an area defined by the periphery;

an inlet located on the upper layer or the bottom layer, the inlet comprising an inlet passageway configured to receive a flow of air from a source and to provide the flow of air to the plurality of interconnected air passageways.

### Embodiment 68

The warming blanket of embodiment 67, further comprising a first end oriented opposite from a second end, wherein the first layer and the second layer meet at the first end and the second end.

### Embodiment 69

The warming blanket of embodiment 68, wherein the first layer is capable of withstanding a static load of a 300 lb patient when suspended from the first end and the second end.

### Embodiment 70

The warming blanket of embodiment 67, further comprising a handle coupled to the first layer.

### Embodiment 71

The warming blanket of any of embodiments 67 to 70, wherein the first layer has a tensile strength of at least 16 N/cm.

### Embodiment 72

The warming blanket of any of embodiments 67 to 71, further comprising a coupling element.

### Embodiment 73

The warming blanket of embodiment 72, wherein the coupling element is a loop.

### Embodiment 74

The warming blanket of embodiment 73, wherein the first layer has an inner surface and an outer surface, wherein the loop is formed from an end portion of the inner surface contacting a portion of the inner surface and mechanically coupled.

### Embodiment 75

The warming blanket of any of embodiments 67 to 74, wherein the first layer comprises one or more straps embedded therein.

### Embodiment 76

The warming blanket of any of embodiments 67 to 75, wherein the first layer comprises one or more reinforcing fibers embedded therein.

### Embodiment 77

The warming blanket of any of embodiments 67 to 75, wherein the first layer one or more loops mechanically coupled to a bottom face of the first layer of a size sufficient to hold a strap.

### Embodiment 78

The warming blanket of any of embodiments 67 to 77, further comprising a low-friction coating disposed on the bottom face of the first layer.

### Embodiment 79

The warming blanket of any of embodiments 67 to 78, further comprising one or more handles mechanically coupled to the first layer having at least one portion disposed outside of the periphery.

### Embodiment 80

A patient moving system, comprising:

corrugated plastic board comprising:
a first layer;
a second layer;
a plurality of support columns contacting both the first layer and the second layer,
wherein a plurality of channels are formed from at least two support columns and the first layer and the second layer,
wherein a plurality of perforations are formed within the second layer, at least some of the plurality of perforations are fluidically coupled to the plurality of channels;

a fluidic manifold comprising:
an inlet formed from at least one layer of material of the fluidic manifold,

wherein the inlet is configured to receive a fluid from a fluidic source;
an chamber formed from the layer,
wherein the chamber is fluidically coupled to the plurality of channels.

### Embodiment 81

The patient moving system of embodiment 81, wherein the chamber further comprises one or more baffles mechanically coupled to the layer.

### Embodiment 82

The patient moving system of embodiment 80 or 81, further comprising an air source coupled to the inlet.

### Embodiment 83

The patient moving system of any of embodiments 80 to 82, wherein the fluidic manifold is disposed on the first layer, the fluidic manifold is fluidically coupled to the plurality of channels, wherein the periphery of the corrugated plastic board is hermetically sealed.

### Embodiment 84

The patient moving system of any of embodiments 80 to 83, wherein the corrugated plastic board has a first end having a first height dimension and a second end having a second height dimension, wherein the first height dimension is greater than the second height dimension.

### Embodiment 85

The patient moving system of any of embodiments 80 to 84, wherein the plurality of perforations are have a chevron pattern across the second layer.

### Embodiment 86

The patient moving system of any of embodiments 80 to 85, wherein the corrugated plastic board has a hole formed therein, wherein the hole is formed from a cut-away section of the corrugated plastic board.

### Embodiment 87

The patient moving system of embodiment 86, further comprising a second corrugated plastic board disposed on the first layer of the corrugated plastic board.

### Embodiment 88

The patient moving system of any of embodiments 80 to 87, wherein the chamber of the manifold has a tear-shaped cross-sectional area across the width dimension of the manifold.

### Embodiment 89

The patient moving system of any of embodiments 80 to 88, wherein the tear-shaped cross-sectional area comprises a major portion fluidically coupled to the inlet and a tapering portion fluidically coupled to the plurality of channels.

### EXAMPLES

### Example 1 (EX1)

A wooden frame structure was constructed as shown in FIGS. 13A-13B. A pair of rails were attached to the wooden frame at the head and foot, and a second pair of rails were screwed into two-by-fours that attached to the support structure. The support structure was created by screwing two-by-fours together to form a rectangular frame. Ten nylon ratchet straps (commercially purchased from Walmart under the trade designation Import, model number:GL4210) having a width of approximately 1 inch. were placed longitudinally across the wooden frame, running perpendicular to the rails. The straps were secured by attaching a hook portion to the strap and looped around the support structure with an applied tension from 2500 N to 4000 N per strap, thus having a tension of 984 N/cm to 1575 N/cm. Each nylon strap was connected to a ratchet. An additional two nylon ratchet straps were wrapped around the support structure perpendicular to the ten longitudinal nylon straps and their two respective cubes at the head and foot of the bed at approximately the same level as a head and foot. Handles were attached to the front face of the support structure to aid in pulling.

### Example 2 (EX2)

A system was constructed as shown in FIGS. 14A-E. A manifold approximately 30.25 inches along a width dimension was created using 3D printing. Alternating portions of Acrylonitrile Butadiene Styrene (ABS) commercially available from Lulzbot, from Aleph Objects Inc. (Colorado, USA) with a size 3 mm filament and thermoplastic polyurethane commercially available under the trade designation NinjaFlex from Ninjatek (Manheim, Pa.) were 3D printed in sections and were assembled by putting the knobs, printed on one end of the next section, into the holes of the one before it. The ABS and NinjaFlex were printed on a Lulzbot Taz 6 3D printer, from Aleph Objects Inc. (Colorado, USA). The center section of the diffuser has a port that the blower is inserted into. This was printed using 1.75 mm polylactic acid filament (PLA) commercially available from Hatchbox using a MonoPrice Mini Select 3D printer from Monoprice Inc. (California, USA). The interior of each piece was designed to have a spiral shape that led to an opening at the bottom of the manifold.

A corrugated plastic board, commercially available under the trade designation Corruboard by Demco (Madison, Wis.) was cut to a longitudinal dimension of 84.5 inches and a width dimension of 35 inches. The corrugated plastic board had a channel dimension of 5.5 mm by 4 mm. Perforations were created by poking manually in a downward chevron pattern in the bottom of the board toward the top of the board.

A plurality of 2 inch by 2 inch squares were stenciled and perforations were created along the diagonal of the square. The perforations were initially centralized along the center of the board expanding approximately where the patient's shoulders, hips, and thighs would rest. Handles were attached using tape and adhesive. The board was taped to the manifold to ensure that air would not be lost to the environment.

Test Method:

The systems of EX1 and EX2 were loaded with weights according to Table 1 and Table 2 to represent the normal distribution of weight in a human.

For example, in EX1, at least four cubes weights were secured to the top of the flexible member with two cubes at each end, approximately just above the head of an average patient and just below the feet respectively.

In EX2, the patient moving system was activated using a blower commercially available under the trade designation, Air-Matt, model AMT-100, Air Movement Technologies (New York, USA)) having a measured volumetric flow rate of 0.0386 m³/s. The number of perforations were spaced at least 2 inches apart.

The lateral transfer force was measured using two calibrated handheld fish scales commercially available as Dr. Meter brand, model number EF-PF01, Hisgadget, Inc. (Union City, Calif.). Each scale was attached to a handle on one side of the patient moving system and one person pulled on both scales at least 5 times. The results are shown in table 1 for EX1, and table 2 for EX2.

TABLE 1
Lateral transfer force of EX1. Weight in
pounds and force in kilograms.

| | |
|---|---|
| EX1 | Pull Force (kg) |

| Weight (lb.) | Avg | St. Dev. |
|---|---|---|
| 35 | 4.7 | 0.089443 |
| 70 | 5.04 | 0.162481 |
| 105 | 6.86 | 0.215407 |
| 140 | 8.38 | 0.337046 |
| 185 | 9.92 | 0.09798 |
| 258 | 15.4 | 2.6533 |
| 303 | 20.8 | 1.16619 |

TABLE 2
Lateral transfer force of EX2 Weight in pounds and force in kilograms.
Average Transfer Force (kg)

| Weight | | Number of perforations | | | | | | | | | |
|---|---|---|---|---|---|---|---|---|---|---|---|
| (lb.) | Control | 4 | 8 | 20 | 38 | 54 | 78 | 106 | 140 | 196 | 224 |
| 0 | 0.38 | 0.428 | 0.392 | 0.308 | 0.264 | 0.278 | | | | | |
| 12.5 | 2.38 | 1.5 | 1.2 | 1.04 | 0.72 | 0.572 | | | | | |
| 35 | 4.94 | 3.74 | 2.16 | 2.42 | 1.54 | 1.48 | 1.7 | 1.024 | 0.398 | 0.54 | 1.158 |
| 47.5 | 7.2 | 6.02 | 3.66 | 3.54 | 1.81 | 2.16 | | | | | |
| 57.5 | 9.62 | 6.82 | 4.92 | 4.4 | 3.14 | 2.38 | | | | | |
| 70 | 7.94 | 6.34 | 4.05 | 4.4 | 3 | 2.38 | 1.52 | 1.76 | 0.908 | 1.436 | 1.76 |
| 82.5 | 9.62 | 9.7 | | | 4.34 | 3.02 | | | | | |
| 105 | 10.66 | 11.78 | | | 4.1 | 4.1 | 4.16 | 3.92 | 1.828 | 2 | 2.71 |
| 125 | 13.7 | | | | 6.1 | | | | | | |
| 150 | 16.7 | | | | 8 | | 4.54 | 4.38 | 3.66 | 2.58 | 4.04 |
| 193 | 21.66 | | | | 15.8 | | 17.2 | 7.44 | 6.82 | 5.6 | 7.22 |
| 258 | | | | | | | 16.2 | 16 | 13.18 | 16.14 | 18.1 |
| 303 | | | | | | | | | 16.2 | 21 | |

What is claimed is:

1. A patient moving system, comprising:
a support structure comprising:
a first support member;
a second support member and a third support member coupled to the first support member, the second support member is arranged parallel to the third support member;
a flexible member removably attached to the second support member and the third support member;
a tensioning device mechanically coupled to at least the flexible member and configured to provide tension to the flexible member.

2. The patient moving system of claim 1, wherein the support structure comprises
a longitudinal dimension corresponding to an anteroposterior axis of a patient; and
a width dimension corresponding to a mediolateral axis of the patient;
wherein the first support member is arranged parallel to the longitudinal dimension;
wherein the second support member is arranged parallel to the width dimension.

3. The patient moving system of claim 1, wherein the second support member is coplanar with the third support member.

4. The patient moving system of claim 1, wherein the tensioning device is configured to tension the flexible member along an axis parallel to the first support member.

5. The patient moving system of claim 1, wherein the tensioning device is a ratchet system.

6. The patient moving system of claim 1, further comprising a sliding mechanism coupled to a portion of the support structure.

7. The patient moving system of claim 6, wherein the sliding mechanism further comprises:
a first slide frame having a first end and a second end;
a first carriage having a first end slidably supported by the first slide frame, movable between a first extended position wherein the first end of the first carriage is between the first end and the second end of the first slide frame, and a home position wherein the first end of first slide frame is aligned with the first end of the first carriage;
wherein at least a portion of the support structure is mechanically coupled to a portion of the sliding mechanism.

8. The patient moving system of claim 7, wherein the sliding mechanism is attached to a base having a plurality of wheels or bearings, further comprising:
a first support column attached to the base at a first end thereof.

9. The patient moving system of claim 1, wherein first support member comprises a first section and a second section, wherein the first section is slidably coupled to the second section, wherein at least the first section is mechanically coupled to the tensioning device.

10. The patient moving system of claim 1, wherein tensioning device comprises a stoppage mechanism to prevent over tensioning, wherein the stoppage mechanism comprises a ratchet system to prevent unintentional release of tension.

11. The patient moving system of claim 1, wherein the tensioning device comprises a lever mechanism.

12. The patient moving system of claim 1, wherein the tensioning device comprises a gear assembly.

13. The patient moving system of claim 1, further comprising a second tensioning device configured to tension the flexible member along an axis perpendicular to the first support member, wherein the second tensioning device is mechanically coupled to the second support member, wherein the second support member comprises a first section slidably coupled to a second section, wherein the second tensioning device causes and end of the first section to slide away from an end of the second section.

14. The patient moving system of claim 1, wherein the flexible member, comprises:
a structure comprising a first layer of material and a second layer of material,
the first layer of material forming a bottom layer of the flexible member, and
the second layer of material forming an upper layer of a warming blanket, the upper layer configured to allow a profusion of air to pass through the upper layer, the upper layer coupled to the bottom layer around a periphery of the bottom layer to form an initial shape and to form an interior space between the first layer of material and the second layer of material comprising a plurality of interconnected air passageways, wherein the plurality of interconnected air passageways are defined by a plurality of seals formed between the upper layer and the bottom layer within an area defined by the periphery;
an inlet located on the upper layer or the bottom layer, the inlet comprising an inlet passageway configured to receive a flow of air from a source and to provide the flow of air to the plurality of interconnected air passageways.

15. A method of moving a patient, comprising:
sliding a flexible member of a patient moving system comprising a first support member, a second support member, and a third support member under a patient;
attaching the flexible member to the second support member and the third support member; and
applying tension to the flexible member by moving the second support member laterally and in an opposite direction from the third support member; wherein a tensile force is at least 8 N/cm;
allowing the patient to move from a first height to a second height.

16. The method of claim 15, further comprising:
applying a lateral force sufficient to move the patient to a first extended position along the first and second sliding mechanism.

17. The method of claim 15, further comprising
attaching the flexible member to the first support member and a fourth support member; and
applying tension to the flexible member by moving the first support member laterally and in an opposite direction from the fourth support member; wherein the tensile force is at least 8 N/cm;
allowing the patient to move from a first height to a second height.

18. A patient moving system, comprising:
corrugated plastic board comprising:
a first layer;
a second layer;
a plurality of support columns contacting both the first layer and the second layer,
wherein a plurality of channels are formed from at least two support columns and the first layer and the second layer,
wherein a plurality of perforations are formed within the second layer, at least some of the plurality of perforations are fluidically coupled to the plurality of channels;
a fluidic manifold comprising:
an inlet formed from at least one layer of material, wherein the inlet is configured to receive a fluid from a fluidic source;
a chamber formed from the material,
wherein the chamber is fluidically coupled to the plurality of channels.

19. The patient moving system of claim 18, wherein the corrugated plastic board has a first end having a first height dimension and a second end having a second height dimension, wherein the first height dimension is greater than the second height dimension.

20. The patient moving system of claim 19, further comprising a second corrugated plastic board disposed on the first layer of the corrugated plastic board,
wherein the corrugated plastic board has a hole formed therein, wherein the hole is formed from a cut-away section of the corrugated plastic board.
